(19) United States
(12) Patent Application Publication
(10) Pub. No.: US 2009/0131263 A1
(43) Pub. Date: May 21, 2009

(54) Normalization methods for G-protein coupled receptor membrane array

(76) Inventors: Longying Dong, Elmira, NY (US); Yulong Hong, Painted Post, NY (US); Joydeep Lahiri, Painted Post, NY (US); Fang Lai, Painted Post, NY (US); Li Liu, Painted Post, NY (US); Jeffrey G. Lynn, Tioga, PA (US)

Correspondence Address: CORNING INCORPORATED, SP-TI-3-1, CORNING, NY, 14831, US

(21) Appl. No.: 11/985,990

(22) Filed: Nov. 19, 2007

(51) Int. Cl. C40B 20/04; C40B 40/10; C40B 50/14

(52) U.S. Cl. 506/4; 506/18; 506/30

(57) ABSTRACT

Reference membrane components are either pre-labeled or labeled during assays for purposes of normalizing signals associated with binding or functional assays employing G-protein coupled receptor microarrays. A reference component may be included in a membrane in which the target GPCR is embedded or may be present in another membrane printed in conjunction with the target membrane on a microspot. Or, a GPCR microarray may be pre-labeled by incorporating a label on an exposed substrate in a defect in the printed microspot.

### FIELD

The present disclosure relates, inter alia, to membrane microarrays, particularly G-protein coupled receptor (GPCR) membrane microarrays, and more particularly to arrays and methods configured to account for variability associated with assays performed using GPCR membrane microarrays.

### BACKGROUND

Membrane associated G-protein coupled receptor (GPCR) array technology is useful for both GPCR ligand binding assays and for functional assays; e.g., the ability of a GPCR ligand to effectuate a change in GTP binding status of guanine nucleotide-binding proteins (G-proteins). Such GPCR membrane arrays have the potential for large scale screening of many putative ligands for drug discovery, research purposes, and the like. However, such membrane arrays have several drawbacks relative to nucleotide or protein-based arrays.

For example, GPCR membrane array assays tend to be a great deal more complex than DNA microarray assay. As opposed to relatively pure and homogeneous DNA samples, membrane preparations isolated from cells can be heterogeneous. In addition, GPCR assays can be much more complicated than DNA microarray assays in which nucleotide to nucleotide interactions occur. For example, the ligands that may functionally interact with GPCR are much more varied and include biogenic amines, peptides and proteins, lipids, nucleotides, excitatory amino acids and ions, small chemical compounds, etc. A particular GPCR could couple with one or more trimeric G-proteins. The binding affinities of agonists to a GPCR may depend on the coupling state of the receptor with its G proteins. In addition, compounds that bind the receptor might have different functionalities, such as agonism, antagonism, super-agonism, or inverse agonism. Further, the binding sites might be different for different compounds binding to the same receptor. Buffer compatibility and optimization for GPCR membrane assays also needs to be carefully considered as changes in the buffer composition can not only affect the functionality of the membrane proteins including the GPCR and G-proteins, but also can affect the binding affinity of ligands to the receptors. Due in part to the complexity of GPCR membrane array assays, assay to assay variability tends to be greater with GPCR arrays than with DNA arrays.

Another source of such variability arises from the heterogeneic nature of GPCR membrane preparations, particularly those isolated from cells. Some preparations are obtained directly from crude cell lysates with a simple centrifugation procedure, while others may undergo an extra sucrose gradient purification procedure. Depending on the cell types and the GPCRs over-expressed in the cells, GPCR membrane preparations can have different fragment distributions. GPCR membrane preparations also tend to aggregate during storage.

Problems associated with printing membranes onto a substrate serve as another source of variability associated with GPCR membrane array assays. Printing problem can include pin clogging, missing spots, and pattern-printing and are in part due to the complex chemical nature of the membrane preparations. For example, membrane preparations isolated from cells will include phospholipids, fatty acids, peripheral and integral membrane proteins, cholesterols and oligosaccharides.

In addition, GPCR membrane array assays generally do not have inherent normalization methods like DNA arrays assays often do. DNA arrays assays, for example, may include hybridizing RNA expressed from a first cell type, e.g. cancer cells, labeled with a first label and RNA expressed from a second cell type, e.g. non-cancer cells, labeled with a second label. The relative intensities of signals from the first and second labels following hybridization to a particular DNA microspot on the array may be compared to determine whether differential expression exists between the first and second cell type. Because of the ability to compare the ratio of signals, variability in amount of DNA printed in any given microspot, or assay conditions that might result in loss of DNA at the given microspot, does not greatly affect the ability to obtain valuable information from such DNA array assays. To the contrary, the quality of data obtained from GPCR membrane array assays is greatly affected by such printing variability and variable losses due to assay conditions; e.g. rinsing causing loss of membrane from a microspot. In a typical GPCR membrane array assay, whether a ligand binding assay or function assay, the relative intensity of signal at a given microspot is often compared to the relative intensity at another microspot. If variable amounts of membrane are printed on the microspots or if variable amounts of membrane are lost from microspots during the assay, the ability to obtain meaningful data from the GPCR assay can be greatly diminished.

### BRIEF SUMMARY

The present disclosure presents, inter alia, arrays and methods that reduce the assay effects of variability in the amount of membrane associated with a microspot of a GPCR membrane microarray and may provide insight into a source of the variability. A labeled agent that binds a reference component of a membrane provides a basis for normalizing signals associated with the GPCR binding or functional assays. The reference component may be included in a membrane in which the target GPCR is embedded or may be present in another membrane printed in conjunction with the target membrane on a microspot.

In an embodiment, a reference prelabeled GPCR membrane array is described. The array has plurality of assayable microspots. One or more of the plurality of the microspots include a membrane having (i) a membrane component and (ii) a direct In-spot target GPCR embedded the membrane. The one or more microspot further includes a labeled agent bound to the membrane component. The labeled agent bound to the membrane component may provide a signal against which signals associated with binding or functional assays of the target GPCR may be normalized.

In an embodiment, a reference prelabeled GPCR membrane array is described. The array has plurality of assayable microspots. One or more of the plurality of the microspots include a first membrane comprising a target GPCR embedded the membrane. The one or more microspots further include a second membrane comprising a membrane component and a labeled agent bound to the membrane component. The labeled agent bound to the membrane component may provide a signal against which signals associated with binding or functional assays of the target GPCR may be normalized.

In an embodiment, a method is described. The method includes isolating a membrane from a cell overexpressing a GPCR. The membrane includes a component. The method further includes contacting the membrane with a labeled agent configured to bind the component to produce a pre-labeled membrane. In addition, the method includes printing the pre-labeled membrane as a microspot on a substrate.

In an embodiment, a method is described. The method includes isolating a first membrane from a cell overexpressing a GPCR and isolating a second membrane from a non-overexpressing cell. The second membrane has a component. The method further includes contacting the second membrane with a labeled agent configured to bind the component to produce a pre-labeled second membrane. In addition, the method includes printing the first and pre-labeled second membrane as a microspot on a substrate. The method includes contacting the second membrane with more than one labeled agent to produce a pre-labeled second membrane.

In an embodiment, a method is described. The method includes contacting a microspot of a GPCR membrane array with labeled non-hydrolysable GTP analog. The method also includes contacting the microspot with a first labeled agent configured to bind a membrane component other than the GPCR to produce a reference labeled membrane. The method further includes contacting the microspot with a ligand suspected of being capable of functionally interacting with the GPCR. In addition, the method includes rinsing the microspot to remove unbound labeled non-hydrolysable GTP analog, unbound first labeled agent, and unbound ligand from the microspot. The method also includes quantifying a first signal associated with the labeled non-hydrolysable GTP analog associated with the microspot and quantifying a second signal associated with the first labeled agent bound to the membrane component. Further, the method includes comparing the first signal with the second signal to determine the extent of the functional interaction of the agent with the GPCR.

In an embodiment, a method is described. The method includes contacting a microspot of a GPCR membrane array with a labeled ligand. The method also includes contacting the microspot with a labeled agent configured to bind a membrane component other than the GPCR to produce a reference labeled membrane. The method further includes rinsing the microspot to remove unbound labeled ligand and unbound labeled agent. In addition, the method includes quantifying a first signal associated with the labeled ligand associated with the microspot and quantifying a second signal associated with the labeled agent bound to the membrane component. Further, the method includes comparing the first signal with the second signal to determine the extent of binding of the agent to the GPCR.

In an embodiment, a method is described. The method includes contacting a microspot of a GPCR membrane array with a labeled ligand. The method includes contacting the microspot with a labeled agent where the labeled agent may be configured to bind to a GPCR, and contacting the microspot with another labeled agent where the second labeled agent may be configured to bind to a membrane or a membrane component, or to an area within a microspot of a GPCR membrane array that may not be coated with membrane, for example, an area of substrate. The labeled agent may be hydrophilic, such as a cytosolic protein. The method further includes rinsing the microspot to remove unbound labeled ligand and unbound labeled agent. In addition, the method includes quantifying a first signal associated with the labeled ligand associated with the microspot and quantifying a second signal associated with the labeled agent bound to the membrane component. Further, the method includes comparing the first signal with the second signal to determine the extent of binding of the agent to the GPCR by providing arrays and methods that account for sources of variability in GPCR array assays, the potential for such assays may be more fully realized. In addition, the ability to determine whether decreased signal associated with a GPCR membrane array assay is due to decreased amounts of the membrane being bound to the array, e.g. either lost via the assay or due to a printing problem, or is due to assay conditions affecting ligand binding or functional interaction, can serve as a valuable source for troubleshooting. These and other advantages will be readily understood from the following detailed descriptions when read in conjunction with the accompanying drawings

### BRIEF DESCRIPTION OF THE DRAWINGS

FIG. 1 is a schematic perspective view of a representative GPCR membrane microarray.

FIGS. 2-5 are schematic diagrams of a representative GPCR membrane microarrays and associated assay reactions.

FIGS. 6A-B are scatter plots of total binding and non-specific binding signals before (6A) and after (6B) normalization.

FIGS. 7A-D are bar graphs of total binding and assay specificity for prelabeled and non-prelabeled membrane preparations printed on a microarray.

FIGS. 8A-C are images of fluorescent signals from microspots of an array. The detected signals are associated with binding of ligand to target GPCR (8A) and agent to reference component of target membrane before (8B) or after (8C) assay.

FIGS. 9A-B are a bar graphs of binding assay signals obtained from assays as described herein.

FIG. 10A is a bar graph of an assay CV obtained from assays as described herein.

FIG. 10B is a bar graph of a Z factor of an assay as described herein

FIGS. 11A-C are bar graphs of pre-scan fluorescence, autofluorescence and assay total signals obtained from an assay as described herein.

FIGS. 12A and 12B illustrate specificity and Z factor related to an assay described herein.

The drawings are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar.

### DETAILED DESCRIPTION

In the following detailed description, reference is made to the accompanying drawings that form a part hereof, and in which are shown by way of illustration several specific embodiments of devices, systems and methods. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, an and “the” encompass embodiments having plural referents, unless the content clearly dictates otherwise. As used in this specification and the appended claims, the term “or” is generally employed in its sense including “and/or” unless the content clearly dictates otherwise.

As used herein, “array” and “microarray” are used interchangeably.

As used herein, “microspot” means a discrete or defined area, locus, or spot on the surface of a substrate, containing a biological or chemical probe.

As used herein, “GPCR” means a guanine nucleotide-binding protein-coupled receptor. The GPCR can have either a natural or modified sequence.

As used herein, “label” means a molecule that produces a detectable signal, such as a fluorescent or radioactive signal, or a molecule that is configured to bind (directly or indirectly) with a molecule that produces a detectable signal, such as a biotin configured to bind a fluorescently labeled avidin. Thus, a “labeled” molecule is a molecule to which a label is bound.

As used herein, “binds”, “bind”, “binding” or the like, in the context of a ligand to a GPCR or an agent to a membrane component, refers to an association of the ligand or agent to the GPCR or membrane component that retains the ligand or agent in close proximity to the GPCR or membrane component when subjected to GPCR membrane assay conditions. The “binding” may be non-covalent or covalent. Examples of non-covalent binding include non-specific adsorption, binding based on electrostatic (e.g. ion, ion pair interactions), hydrophobic interactions, hydrogen bonding interactions, surface hydration force and the like. A ligand or agent that “selectively binds” a GPCR or membrane component has an appreciably greater affinity for the GPCR or membrane component than for other components of the membrane. A ligand may also bind to a surface.

As used herein, “assayable”, in the context of an array or a microspot of an array, means that the array or microspot contains material that is capable of being assayed under typical assay conditions. By way of example, a microspot or array that has not yet been subjected to an assay is typically an assayable microspot.

As used herein, “prelabeled”, in the context of a membrane component, means that the membrane component is labeled prior to the membrane being subjected to an assay on an array or microspot, and typically refers to a membrane having a component labeled prior to printing on the array or microspot. A “reference prelabeled G-protein coupled receptor membrane array” is a GPCR membrane array having a microspot with a membrane component or other feature labeled prior to being subjected to an assay.

As used herein, a “non-overexpressing cell”, relative to a cell overexpressing a GPCR, means a cell that is not configured to overexpress the GPCR.

As used herein, “CV” means coefficient of variation. CV is a measure of dispersion of a probability distribution, or the measure of variation for a large data set. CV is the ratio of the standard deviation to the mean and is calculated mathematically as 100×(standard deviation/average signal intensity).

The present disclosure describes, inter alia, arrays and methods to reduce the assay effects of variability in the amount of membrane associated with a microspot of a GPCR membrane microarray. The disclosure presents various embodiments that provide for normalization of signals from microspots in GPCR membrane array assays by providing a quantifiable signal that may be used to compare the amount of membrane associated with a given microspot with that associated with another microspot.

### Arrays

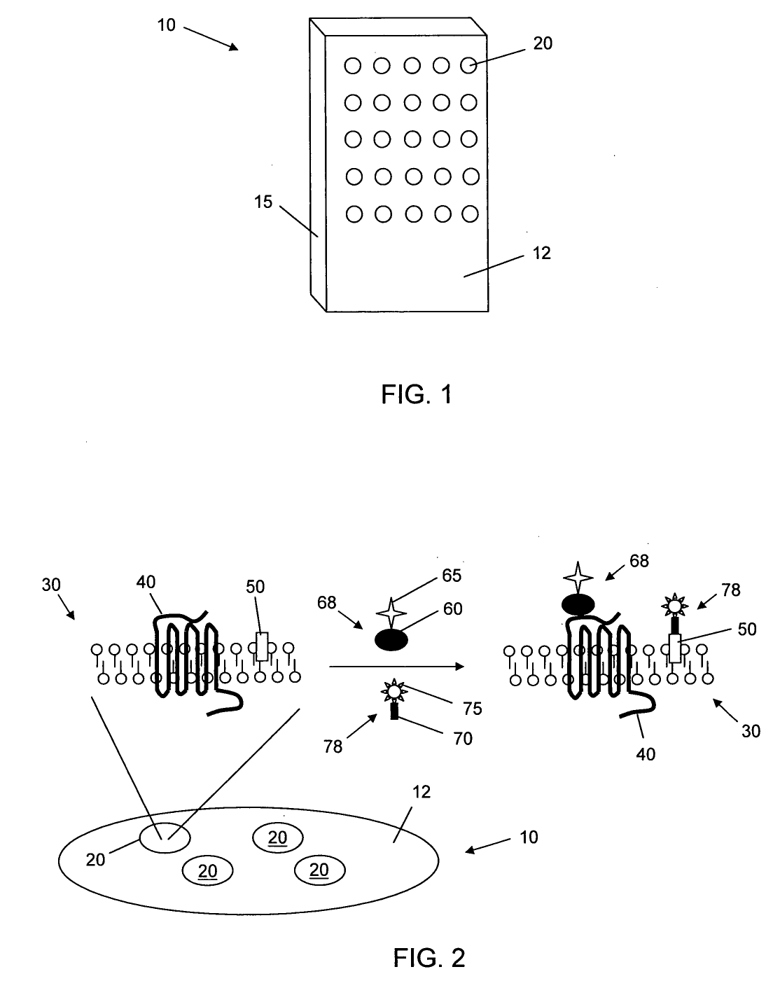

Referring to FIG. 1, an array 10 as described herein includes a substrate 15 having a surface 12. A plurality of microspots 20 are deposited on the surface 12. One or more of the microspots 20 of the array 10 include a membrane of known or unknown composition. The membrane may include a GPCR embedded in the membrane. In various embodiments, more than one type of protein is included in a membrane of a microspot 20. For example, the membrane may include two embedded GPCRs, which may be desirable, for example, for GPCRs that heterodimerize for their biological functions. (Angers, S. et al., Proc. Natl. Acad. Sci. USA, 2000, 97, 3684-3689.) Additionally, for functional GPCR activity, the membrane of a microspot 20 may include necessary co-effectors and/or adaptors. Furthermore, biological membranes from lysated cells that contain a large number of cell surface molecules can be directly used to fabricate biological membrane arrays 10.

A microspot 20 may include one, two or more membranes. The microspots 20 of the array 10 may be any convenient shape, but will typically be circular, elliptoid, oval, annular, or some other analogously curved shape, where the shape may, in certain embodiments, be a result of the particular method employed to produce the array 10. The microspots 20 may be arranged in any convenient pattern across or over the surface 12 of the array 10, such as in rows and columns so as to form a grid, in a circular pattern, or the like.

A microspot 20 may contain defects 21, areas within the microspot 20 which are not layered with membrane. Within these defects 21, the underlying substrate may be exposed. It is possible that labeled agents may bind to the underlying substrate surfaces exposed in these defect areas 21.

The membranes of the microspots 20 are generally stably associated with the surface 12 of a substrate 15; i.e. the membranes of the microspots 20 generally maintain their position relative to the substrate 15 under binding and/or washing conditions. However, it will be understood that some membrane may be removed from the surface 12 of the array 10 during the assay (e.g., during washing steps). The membranes that make up the spots 20 can be non-covalently or covalently associated with the substrate surface 12. Examples of non-covalent association include non-specific adsorption, binding based on electrostatic (e.g. ion, ion pair interactions), hydrophobic interactions, hydrogen bonding interactions, surface hydration force or the like, or specific binding based on the specific interaction of an immobilized binding partner and a membrane bound protein. Specific binding-induced immobilization includes, for example, antibody-antigen interaction, generic ligand-receptor binding, lectin-sugar moiety interaction, etc. Examples of covalent binding include covalent bonds formed between membranes and a functional group present on the surface 12 of the substrate 15, e.g. —NH₂ or CoOH, where the functional group may be naturally occurring or present as a member of an introduced coating material. In another example, histidine-tagged mutations of GPCRs or membrane proteins can bind to Ni-presenting surfaces through chelating bonds.

In various embodiments, an array 10 includes a first microspot 20 having a membrane with a first embedded GPCR or combination of GPCRs and a second microspot 20 having a membrane with a second different embedded GPCR or combination of GPCRs. Of course, the array 10 may have any different number of microspots 20 having different membranes with differing embedded GPCRs or combinations of GCPRs. For example, the array 10 may have 10, 50, 100 or 1000 or more different microspots 20, each having a different GPCR or combination of GPCRs. Each microspot 20 of the array 10 may include a different GPCR or combination of GPCRs. For example, an array 10 including about 100 microspots could include about 100 different proteins. Alternatively, each different GPCR may be included on more than one separate microspot 20 of the array 10. For example, each different GPCR or combinations of GPCRs may optionally be present on two to six different microspots 20.

In various embodiments, the array 10 is fabricated using cell membrane preparations. Such cell membrane preparations contain a large number of different cell surface proteins in addition to the GPCR or combination of GPCRs of interest. In some embodiments, the array 10 includes cell membrane preparations obtained from normal and diseased tissues. The resulting array 10 can be used to compare the pharmacological and physiological characteristics of the tissues.

In various embodiments, more than one of the microspots 20 of the array 10 comprises the same GPCR or combinations of GPCRs of interest but in different amounts or in different embedded environments. For example, the same receptor can be obtained from lysated cell membrane preparations, or from purified receptor re-constituted in liposomes or micelles of different compositions. The resulting array can be used to examine the effect of the environment on the stability and functionality of the receptor. In various embodiments, more than one of the microspots 20 of the array 10 includes the same GPCR of interest but with different mutations, such as point mutations. The resulting arrays 10 can be used to systematically examine the structure and function relationship of the receptor.

In various embodiments, the array 10 includes substantially identical microspots 20 (e.g., microspots 20 including the same GPCRs) or a series of substantially identical microspots 20 that in use are treated with a different analyte (target). For example, an array 10 can include a “mini array” of 20 microspots, each microspot 20 containing a different GPCR, where the mini array is repeated 20 times as part of the larger array 10.

In various embodiments, the GPCRs are related although the GPCR or combination of GPCRs of one microspot 20 is different from that of another. In some embodiments, the two different GPCRs or combination of GPCRs are members of the same family. The different GPCRs may be either functionally related or just suspected of being functionally related. In various embodiments, however, the function of the immobilized GPCRs may be unknown. In such cases, different GPCRS on different microspots 20 of the array 10 may share a similarity in structure or sequence or are simply suspected of sharing a similarity in structure or sequence. In some embodiments, the GPCRs may be fragments of different members of a protein family. In some embodiments, the GPCRs share similarity in pharmacological or physiological distribution or roles.

### Substrate

Still referring to FIG. 1, a substrate 15 of an array 10 as described herein in includes at least one surface 12 on which a pattern of microspots 20 is present. The surface 12 may be smooth or substantially planar, have irregularities, such as depressions or elevations, or be porous. In various embodiments, the substrate is porous and is as described in U.S. pregrant application publication no. 2006/0147993, entitled “Membrane arrays and methods of manufacture”, Jul. 6, 2006.

The substrate 15 may include a ceramic substance, a glass, a metal, a crystalline material, a plastic, a polymer or co-polymer, any combinations thereof, or a coating of one material on another. Such substrates 15 include for example, but are not limited to, (semi) noble metals such as gold or silver; glass materials such as soda-lime glass, pyrex glass, vycor glass, quartz glass; metallic or non-metallic oxides; silicon, monoammonium phosphate, and other such crystalline materials; transition metals; plastics or polymers, including dendritic polymers, such as poly(vinyl chloride), poly(vinyl alcohol), poly(methyl methacrylate), poly(vinyl acetate-maleic anhydride), poly(dimethylsiloxane) monomethacrylate, polystyrenes, polypropylene, polyethyleneimine; cyclic olefins, copolymers such as poly(vinyl acetate-co-maleic anhydride), poly(styrene-co-maleic anhydride), poly(ethylene-co-acrylic acid), cyclic olefin copolymers or derivatives of these or the like.

The substrate 15 may take a variety of configurations ranging from simple to complex, depending on the intended use of the array 10. Thus, the substrate 15 could have an overall slide or plate configuration, such as a rectangular or disc configuration. A standard multi-well microplate configuration can be used. The surfaces of the wells may be modified, e.g., as described in US pregrant patent application publication no. 2002/0094544, entitled “Arrays of biological membranes and methods of use thereof”, Jul. 18, 2002.

The surface 12 on which the pattern of spots 20 is present may be modified with one or more different layers of compounds that serve to modify the properties of the surface 12 in a desirable manner. For example, the array 10 may include a coating material (not shown) on the whole or a portion of the substrate 15 having the microspots 20. The coating material may be used to enhance the affinity of a membrane of the microspot 20 for the substrate. The coating material may be used to enhance the affinity of a labeled ligand for substrate that might be exposed in defects 21 within a microspot 20. Any suitable coating material may be employed. Non-limiting examples of suitable coating material include those having a silane, thiol, disulfide, or a polymer. Further details regarding suitable coating materials are described in US 2002/0094544.

### Biological Membranes

As used herein, “membrane” means a structure having a plurality of amphiphilic molecules into which a GPCR may be embedded. Amphiphilic molecules that may be employed to form membranes include phospholipids, sphingomyelins, cholesterol or their derivatives. A membrane may be synthetic or naturally occurring. For example, membranes may be formed of vesicles, liposomes, monolayer lipid membranes, bilayer-lipid membranes, whole or part of cell membranes, liposomes, detergent micelles, or the like.

For membranes into which a GPCR is incorporated, it is preferable in certain embodiments that the immobilized receptors are associated with one or more of their coeffectors such as G-proteins or G protein coupled receptor kinases (GRKs). In various embodiments, cell membrane preparations from a cell line co-overexpressing a desired receptor and its coeffectors are used. In some embodiments, a reconstituted receptor in a liposome or micelle is used, in which the receptor is associated with one or more preferred coeffectors in a preferable ratio. The coupling of the receptor with its coeffectors can be carried out before or after the receptor is arrayed. The coeffectors can be either purified natural proteins, recombinant proteins with native sequences, or recombinant proteins with unique combinations of subunits such as mutants and chimeras.

The proteins incorporated on a membrane may be produced by any of the variety of techniques known to those of ordinary skill in the art. The proteins may be obtained from natural sources or optionally may be overexpressed using recombinant DNA methods. Proteins include, for example, GPCRs (e.g. the aderenergic receptor, angiotensin receptor, cholecystokinin receptor, muscarinic acetylcholine receptor, neurotensin receptor, galanin receptor, dopamine receptor, opioid receptor, erotonin receptor, somatostatin receptor, etc), G proteins, and other membrane-bound proteins. Mutants or modifications of such proteins may also be used. For example, some GPCRs possessing single or multiple point mutations retain biological functionality and may be involved in disease. (See, Stadel, et al., Trends in Pharmocological Review, 1997, 18, 430-437.)

Additionally, the proteins can also (or independently) be modified to include an agonist (or peptide) attached at the N-terminus. GPCRs modified in such a way can be constitutively activated (Nielsen, S. M. et al., Proc. Natl. Acad. Sci. USA, 2000, 97, 10277-10281).

In various embodiments, a GPCR is immobilized in an oriented manner. For example, to improve performance of GPCR arrays for ligand screening, the GPCRs are oriented with their ligand-binding sites (extracellular domains) to the solution and intracellular domain facing the substrate. This can be accomplished by a number of methods. For example, the surface of the substrate is modified to contain nitrilotriacetic acid (NAT) groups or ethylenediamine triacetic acid (EDTA) groups chelated to nickel. This surface can be used for immobilizing recombinant GPCRs with histidine tags at their C-terminus. Surfaces presenting NTA groups or EDTA groups can be conveniently obtained by silane chemistry on glass or metal oxide surfaces, or via thiol chemistry on gold-coated surfaces. Compounds for these surface chemistries are commercially available (e.g. N-[(3-trimethoxysilyl)propyl) propyl] ethylenediamine triacetic acid; Huls, Inc.).

In an alternative approach for immobilizing GPCRs with their extracellular domains exposed to solution, anti-G-protein antibodies can be used. This approach has the advantage that the G-proteins do not have to be expressed with histidine-tags.

Alternatively, to improve the performance of GPCR arrays for functional assays, the GPCRs are oriented with their intracellular side facing the solution and extracellular domains facing the substrate. This can be accomplished by a number of methods, including, for example, modifying the substrate surface with lectins such as wheat germ agglutinin (WGA). These surfaces can be used for immobilization of GPCRs through glycosylated moieties in the N-terminal of the receptor, or other cell surface moieties present in the cell membrane.

### Printing of Membranes as Microspots of Arrays

Membranes are printed as microspots 20 on a surface 12 of the substrate 15 to generate an array 10. Any suitable printing technique may be employed. As used herein, “printing” means deposition of material onto a substrate. The membranes are typically printed on the substrate 15 using micro-patterning techniques. Such techniques are well known in the art. In various embodiments, the tip of a probe (also referred to as a “pin”) is immersed into a solution of membranes. The tip is removed from the solution to provide solution adhered to the tip. The solution is contacted with the surface 12 of a substrate 15 to thereby transfer the solution from the tip to the surface 12.

A pin for printing membranes on a surface 12 of an array 10 may be of any shape, size, and dimension. For example, the pin printing process may involve ring shaped pins, square pins, or point pins, etc. In some embodiments, the direct contact printing involves single pin printing or multiple pin printing, i.e. a single pin printing method involving a source plate or multiple pin-printing using a laid out array of multiple pins patterned in any format.

The printing apparatus may include a print head, plate, substrate handling unit, XY or XYZ positioning stage, environmental control, instrument control software, sample tracking software, etc. Such an apparatus includes, for example, a quill pin-printer sold by Cartesian Technologies, Inc.

A typographical probe array having a matrix of probes aligned such that each probe from the matrix fits into a corresponding source well, e.g., a well from a microtiter plate, may be used to form a high density array.

A variety of other techniques may also be used to produce an array 10 as described herein. For example, an array 10 can be produced using microstamping (U.S. Pat. No. 5,731,152), microcontact printing using poly(dimethylsiloxane) (PDMS) stamps (Hovis and Baxter, Langmuir, 2000, 16(3):894-897), capillary dispensing devices (U.S. Pat. No. 5,807,522) and micropipetting devices (U.S. Pat. No. 5,601,980). For radioactive assays using membrane arrays 10, pippette-based liquid transfer techniques are useful for fabricating the arrays 10 because such techniques can give rise to spots of larger size with a range of several hundred microns to several mm.

### Uses of Arrays

Arrays 10 as described herein may be used in a variety of GPCR binding and functional assays and may be employed in drug development, medical diagnostics, proteomics or biosensors. A sample that is delivered to the array is typically a fluid.

A wide range of detection methods are applicable to the assays described herein. As desired, detection may be quantitative, semiquantitative, or qualitative. An array 10 can be interfaced with optical detection equipment employing methods such as absorption in the visible or infrared range, chemiluminescence, and fluorescence (including lifetime, polarization, fluorescence correlation spectroscopy (FCS), and fluorescence-resonance energy transfer (FRET)). Furthermore, other modes of detection such as those based on optical waveguides (PCT Publication WO96/26432 and U.S. Pat. No. 5,677,196), surface plasmon resonance, surface charge sensors, surface force sensors, and MALDI-MS may be employed as appropriate or desired.

Assays, as they relate to GPCRs, may be direct, noncompetitive assays or indirect, competitive assays. In noncompetitive methods, the affinity for binding sites on the GPCR is determined directly. In such methods, the proteins in the microspots are directly exposed to the analyte (“the target”). The ligand may be labeled or unlabeled. If the ligand suspected of binding the GPCR is labeled, the methods of detection may include fluorescence, luminescence, radioactivity, etc. If the ligand is unlabeled, the detection of binding may be based on a change in some physical property at the membrane surface. This physical property could be refractive index, or electrical impedance. The detection of binding of unlabeled targets could also be carried out by mass spectroscopy. In competitive methods, binding-site occupancy is determined indirectly. In such methods, the GPCRs of the array are exposed to a solution containing a cognate labeled ligand for the GPCR and an unlabeled ligand suspected of binding the GPCR. The labeled cognate ligand and the unlabeled putative ligand compete for the binding sites on the GPCR. The affinity of the putative ligand for the GPCR relative to the cognate ligand is determined by the decrease in the amount of binding of the labeled ligand. The detection of binding of the suspected ligand can also be carried out using sandwich assays, in which after the initial binding, the array 10 is incubated with a second solution containing molecules such as labeled antibodies that have an affinity for the bound ligand, and the amount of binding of the ligand is determined based on the amount of binding of the labeled antibodies to the GPCR-target complex. The detection of binding of the putative ligand can be carried out using a displacement assay in which after the initial binding of labeled ligand, the array 10 is incubated with a second solution containing compounds of interest. The binding capability and the amount of binding of the suspected ligand are determined based on the decrease in number of the pre-bound labeled ligands.

In various embodiments, assays provide for methods for screening a plurality of GPCRs for their ability to bind a particular component of a target sample. Such methods include delivering the sample to an array 10 including the GPCRs to be screened and detecting, either directly or indirectly, for the presence or amount of the particular component retained at each microspot 20. The assay may further include washing the array 10 to remove any unbound or nonspecifically bound components of the sample from the array 10 before the detection step. In some embodiments, the assay further includes characterizing the particular component retained on at least one microspot 10.

In various embodiments, methods include assaying in parallel for the presence of a plurality of putative ligands in a sample which can react with one or more of the GPCRs on the array 10. This method includes delivering the sample to the array 10 and detecting the interaction of the putative ligands with the GPCR at, e.g, each microspot 20.

Additional binding assays that may be carried out employing arrays and method as described herein are described in US2002/0094544.

### Functional Assays for GPCR Arrays

Arrays 10, in various embodiments, may be used for microarray-based heterogeneous assays to identify the activation and co-effectors of GPCRs. In some embodiments, the assay employs labeled nonhydrolyzable GTP (e.g., radioactive [³⁵S]GTPγS or its fluorescent analogs (e.g. BODIPY-FL-GTPγS, or europium labeled GTPγS (eu-GTP)) to monitor the ligand-stimulated binding of GTPγS to arrays of cell membrane preps containing over-expressed GPCRs and G proteins or reconstituted vesicles/micelles containing the receptor of interest and its co-effectors. This approach not only enables one to screen agonists against GPCRs in a high throughput manner, but also allows one to identify coeffectors (e.g. coupled Gα protein) of the GPCR.

Upon agonist binding, a GPCR undergoes conformational changes to uncover previously masked G protein-binding sites, thereby promoting interaction with heterotrimeric G proteins. This interaction catalyzes guanine nucleotide exchange, resulting in GTP binding to the α subunit of the G protein. GTP binding leads to dissociation of the Gα-GTP complex from the Gβγ subunits. As a consequence of the intrinsic GTPase activity of the Gα subunit, bound GTP is hydrolyzed to GDP, thereby returning the system to its heterotrimeric resting state.

GTPγS is a nonhydrolyzable analog of GTP. The binding of both radioactive and fluorescent GTPγS has been extensively used to measure G protein activation by agonist-bound GPCRs in homogeneous in solution-based assays.

There are diverse groups of G proteins found in tissues and cell types (Morris, A. J. and Malbon C. C., Physiol. Rev., 1999, 79, 1373-1430). Gα proteins can be classified into four families (Gₛ, Gᵢ, G_{q} and G _{12/13}) based on their biological functions and amino acid homology. Moreover, there are at least five Gβ and seven Gγ proteins reported in the literature. Heterotrimeric G proteins are therefore extremely diverse, taking into account the complexity of the combination of three subunits. A GPCR may couple at least one Gα protein. Furthermore, almost all cell lines preferentially express some rather than all Gα proteins. This raises the complexity of analyzing and normalizing the action of ligands to a GPCR-G protein pathway. For example, if the GPCR co-effectors are absent in a given cell line that is overexpressing the GPCR of interest, the results of ligand screening assays may not be very meaningful.

In the absence of ligand-induced activation of the Gα subunit, GTPγS and its analogs bind to members of the Gα proteins with different affinities. For example, BODIPY-FL-GTPγS binds to the unactivated forms of the G proteins Gₒ, Gₛ, Gᵢ₁, and Gᵢ₂ with a K_{d} of 6, 70, 150 and 300 nM, respectively, in reconstituted vesicle systems (McEwen, D. P., et al., Anal. Biochem, 2001, 291, 109-117). This gives rise to different basal lines for fluorescence intensity using BODIPY-FL-GTPγS (or radioactivity counts if [³⁵S]GTPγS is used). However, the agonist-induced Gα activation greatly promotes the binding of GTPγS.

### FIGS. 2-5

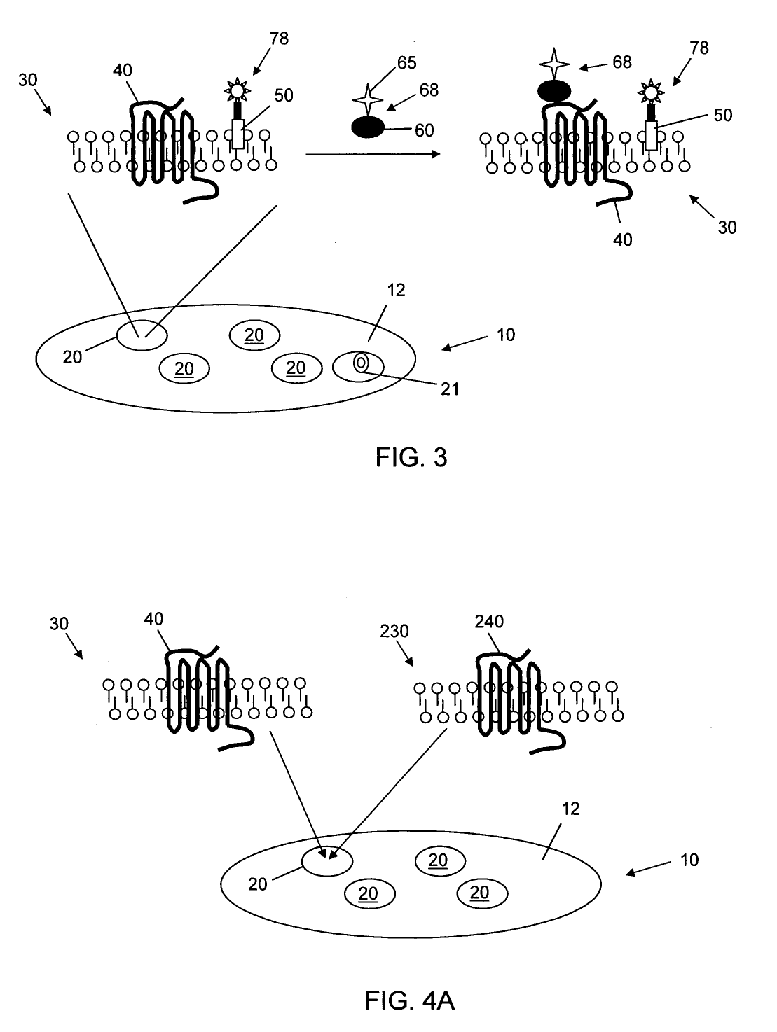

Various embodiments of representative GPCR membrane microarrays 10 and associated assay reactions are shown in FIGS. 2-6. As with FIG. 1, FIGS. 2, 3, 4A, 5A, and 6A show arrays 10 having a plurality of microspots 20 disposed on a surface 12. Referring to FIGS. 2 and 3, a GPCR 40 is associated with a membrane 30 of a microspot 20. The membrane 30 depicted is a lipid bilayer, however it will be understood that membrane 30 may be any suitable membrane, e.g, as discussed above. A membrane component 50 other than the GPCR 40 is also associated with the membrane 30. The membrane component 50 may be any component capable of being associated with a membrane 30 and capable of being labeled and identified as being associated with the membrane. In various embodiments, the membrane component 50 is a component of a membrane isolated from a cell. For example, the membrane component 50 may be a phospholipid, a fatty acid, a peripheral or integral membrane protein, a cholesterol, an oligosaccharide, or the like. In some embodiments, the membrane component 50 includes or is ganglioside G_{M1}. In some embodiments, the membrane component includes or is a phospholipid such as phosphatidylserine. In additional embodiments, the labeled agent may associate with the microspot 20 itself. For example, a labeled protein may bind to or associate with an exposed area of substrate, a defect within a microspot. This binding may also serve as a reference or normalization signal for a GPCR assay. In some embodiments, the membrane component 50 is a second GPCR different from the first GPCR 40.

In additional embodiments, normalization of GPCR assays may be accomplished by incorporating a label into the membrane prep. For example, labeled streptavidin (Sv), or similar labeled proteins may be incorporated into the GPCR membrane preparation, prior to printing. This may be accomplished by sonication in the universal printing buffer containing cy5 or cy3 labeled Sv. This sonication step leads to the association of the labeled Sv to the GPCR membrane prep. Without being bound by a theory, the labeled Sv may be associated with the GPCR membrane prep by means of the hydrophobic dye, for example cy3 or cy5, becoming associated with the lipid membrane. Or, the labeled Sv may become associated with substrate that may be exposed through defects 21 in the printed membrane prep in the deposited microspots 20 (see Fang, et al., Air-Stable G Protein-Coupled Receptor Microarrays and Ligand Binding Characteristics, Anal. Chem. 2006, 78:149-155).

Referring to FIG. 2, a membrane component of a target membrane can be used as a reference for normalization in GPCR assays. As shown in FIG. 2, an agent 70 that selectively binds to membrane component 50 is labeled with a first label 75 (collectively, “labeled agent” 78) and is added to an assay solution and is contacted with microspot 20 containing membrane 30 with associated membrane component 50. The agent 70 may be any agent that selectively binds membrane component 50. In general, agent 70 should have a high affinity for membrane component 50 and should be of a size that will not interfere with binding of ligand 60 with GPCR 40 or interaction of GPCR 40 with its downstream co-effectors such as G-proteins. While membrane component may be located at any location in membrane, preferably membrane component 50 is located a sufficient distance from GPCR 40 and its downstream co-effectors to avoid interfering with ligand 60 binding or functional assays. In various embodiments, agent 70 is an antibody or antibody fragment, such as a Fab′ fragment that recognizes an epitope of membrane component 50. However, in some instances, antibodies may be large enough to interfere with the targeted binding or functional assay. In numerous embodiments, the agent contains the beta subunit of cholera toxin, which selectively binds to ganglioside G_{M1} that may be incorporated into membrane 30 or may be found naturally in membranes isolated from cells. In various embodiments, the agent contains Annexin V that selectively binds to phosphatidylserine. It will be understood that a labeled aptmer may be used a probe for nearly any membrane component.

The assay solution may also include a GPCR ligand 60 that is labeled with a second label 65 (collectively, “labeled ligand” 68). As used herein, “ligand”, in the context of a GPCR, means a molecule that binds to the GPCR. A “ligand” may, in some cases, functionally interact with the GPCR. For example, the ligand may be an agonist, and antagonist, an inverse agonist or the like.

After contact with the assay solution, the array 10 or microspot 20 may be washed, leaving a membrane 30 having labeled ligand 68 bound to GPCR 40 and labeled agent 78 bound to membrane component 50. A signal obtained from the first label 75 from a first microspot 20 may be compared to a signal obtained from a second microspot 20 to account for variability in the amount of membrane 30 in the microspots 20 to allow for normalized comparison of a signal detected from the second label 65 from the first microspot 20 to a signal detected from the second label 65 from the second microspot 20. Within a given membrane preparation, the ratio of GPCR 40 to membrane component 50 should remain constant during the assay. Accordingly, the membrane component 50 may serve as an effective normalization target. While the embodiment depicted in FIG. 2 can result in improvement due to normalization, it may be difficult in some circumstances to achieve uniform labeling of membrane component 50 due to restricted access of the labeled agent 78 to the membrane component 50 when the membrane 30 is bound to surface 12. In addition, it may be difficult in some circumstances to remove free labeled agent 78 under washing conditions associated with a typical assay, which can confound normalization.

Accordingly, in such situations, it may be desirable to pre-label membranes 30 prior to printing the membrane 30 on the surface 12, e.g., as shown in FIG. 3. As shown in FIG. 3, a pre-labeled membrane 30 is printed on a substrate 12. The prelabeled assay or microspot 20 can be treated with a GPCR ligand 60 that is labeled with a second label 65 (collectively, labeled ligand 68) that is labeled with a second label It may be preferable, in order to maintain binding activity and assay specificity, to label GPCR40 with minimum necessary steps to ensure that array printing can occur directly following labeling without going through freezing/thawing process. For example, a simplified prelabeling protocol which produced active prelabeled GPCR membranes is described in Example 3 below. In Example 3, label is provided in a small volume directly in the stock solution and the membrane is washed by adding a carrier protein such as BSA. These steps allow for providing the membrane preparation and membrane printing on the same day. Because printing is a lengthy process that may take for example 5 hours, reducing the time required to prelabel allows a researcher to complete all of the prelabeling steps as well as the printing steps in one day. If the entire protocol can be completed in one day, no freeze-thaw cycle is required. Prior methods have required a freeze-thaw cycle in order to complete all of the necessary steps. In addition, the recovery rates, the percentage of labeled membrane that remains at the end of the protocol, of prior methods have been very low (less than 30%) while recovery rates for embodiments of the methods of the present invention provide recovery rates of greater than 90%.

In embodiments of the present invention, it may be preferable to perform the steps in a minimal volume of stock solution. Stock solution may be provided by a manufacturer or supplier of GPCR membrane preparations. Proteins or membranes suspended in a minimal volume of liquid will be easier to precipitate or recover from the preparation. However, the minimum volume can't be below, for example 15 μl to accommodate the volume of the membrane material. A preferred minimal volume may be less than 100 μl, between 20 to 75 μl, between 25 and 50 μl, or between 25 and 40 μl.

Prelabel GPCR40 prior to array printing allows for improved labeling efficiency and reduce background signal that results in improved normalization. In addition, prelabeled GPCR40 allows one to monitor membrane retention and troubleshooting of missing spots associated with printing, washing, and binding assay; This will allow one to determine whether decreased binding of ligand 60 to GPCR 40 during an assay is due to loss of membrane 30 during the assay (e.g., during washing), incomplete printing, or loss of binding activity for unknown reason (See Example 3). Prelabeled GPCR40 also allows one to perform quality control before a complex process of binding assay occurs which is greatly beneficial to time and financial saving.

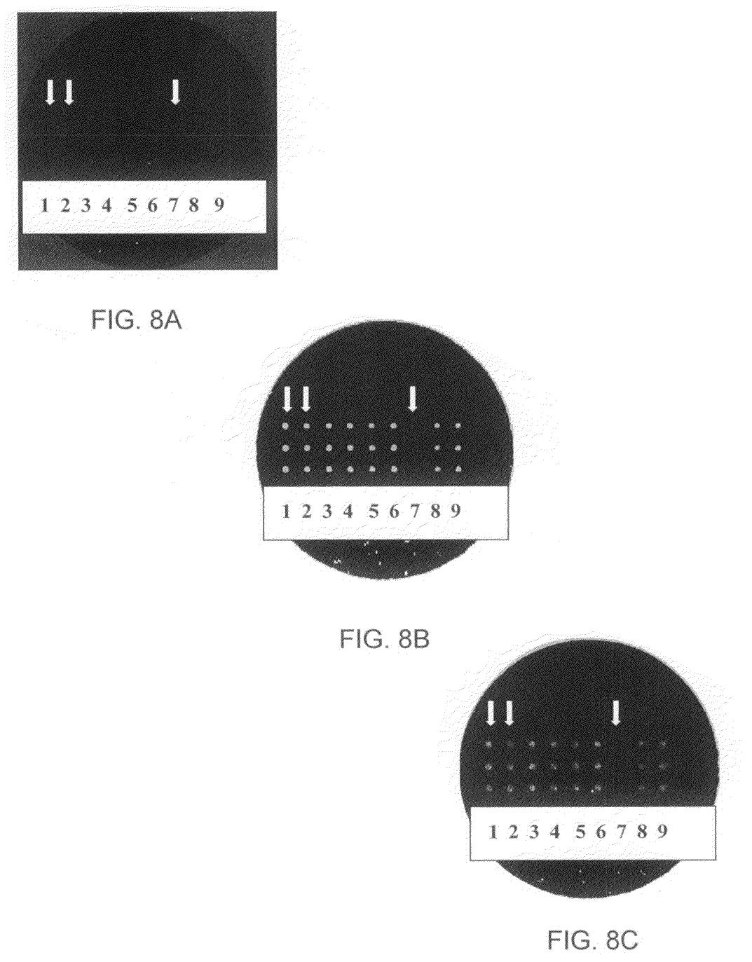

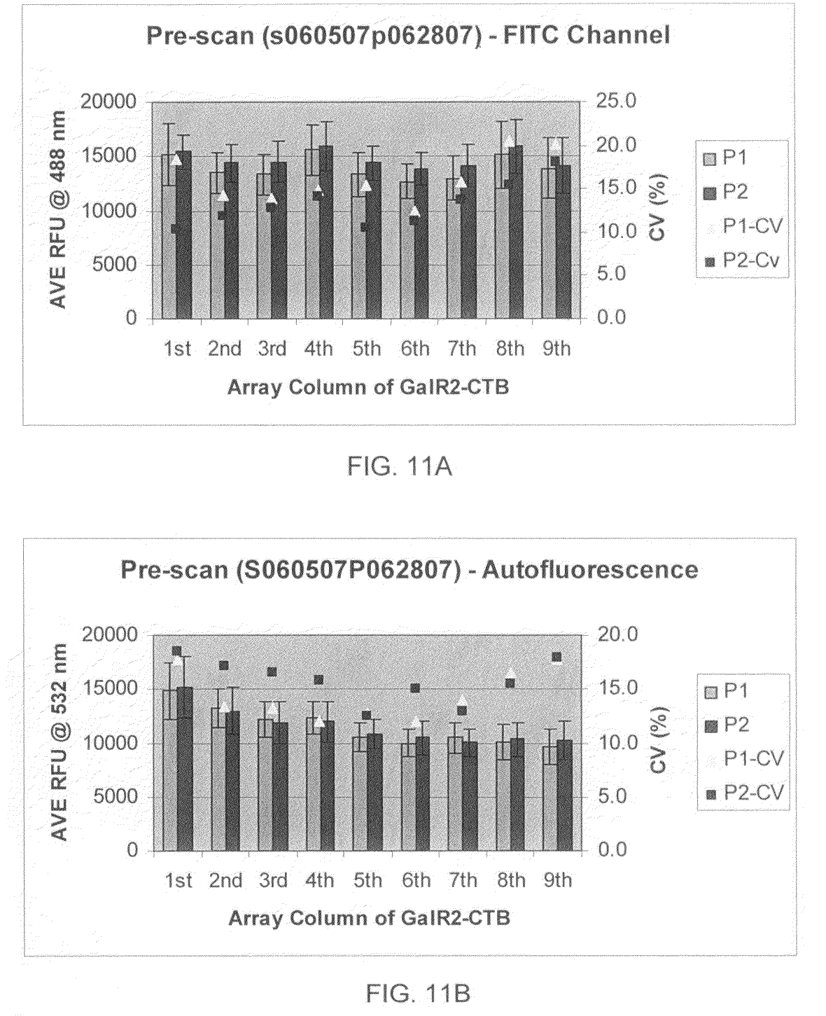

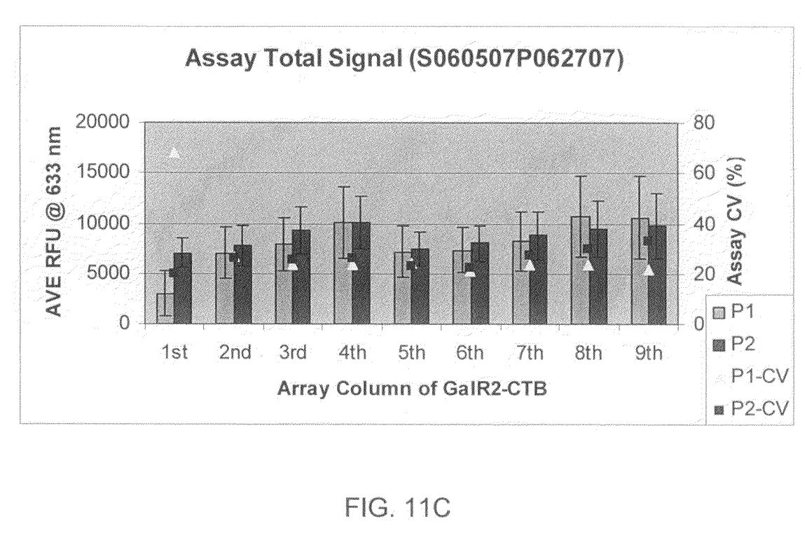

Embodiments of the present invention may provide significant advantages for GPCR assays. For example, the use of a prelabeled membrane can be used to monitor membrane retention during the binding assay. As shown in FIG. 8B (before assay) and FIG. 8C (after assay) all of the membranes are present except for 7, FIGS. 8B and 8C illustrate that the membrane (7) failed to print. However, the results shown in FIG. 8A show that there is no signal in columns 1 and 2. Using previous methods, one may have read the results as showing that the membranes were not properly printed in columns 1 and 2. However, using a pre-labeling method, it can be seen that only column 7 failed to print. See Example 3 (C). Quality control may also be improved. Previous methods used autofluorescence to monitor the quality after printing, but before assay. With a prelabeled membrane, it is possible to check the quality of printing directly by looking at the prelabeled fluorescence. This is more accurate with regard to analyzing the final results of the assay. See, for example, FIGS. 11A-11C. In addition, this prelabeling method can be used for normalization.

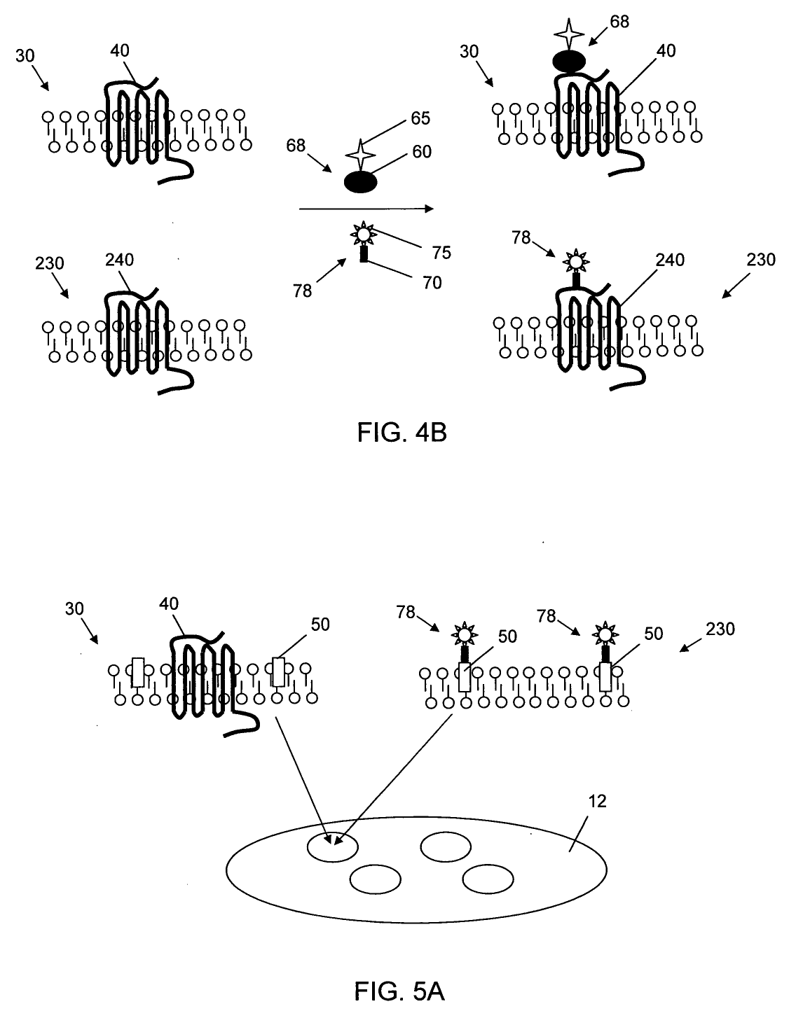

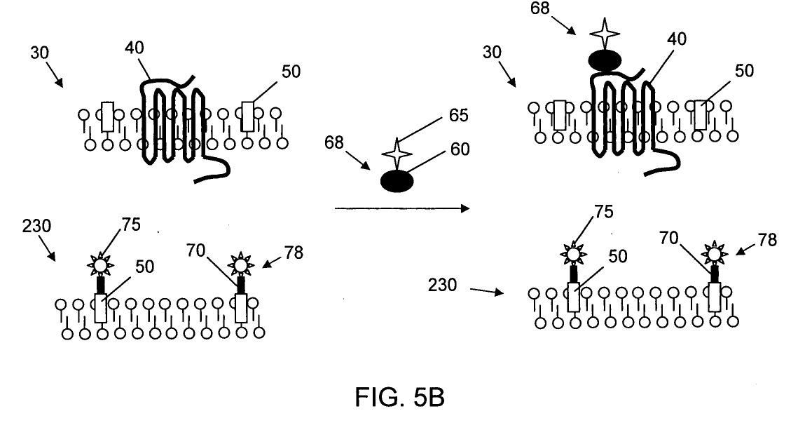

Referring to FIGS. 4 and 5, a second reference membrane 230 may be employed to serve for purposes of normalization. The target membrane 30 and the reference membrane 230 are printed together on a microspot 20. The target membrane 30 and the reference membrane 230 may be mixed prior to printing. The reference membrane 230 is preferably similar to target membrane 30. For example, target membrane 30 may be a membrane isolated from cells overexpressing the GPCR 40 and reference membrane 230 may be isolated from cells having a common lineage as the cells from which the target membrane 30 is obtained, but which do not overexpress the GPCR 40. The reference membrane 230 may be pre-labeled prior to printing or may be labeled during the GPCR assay directed at the target membrane 30.

In the embodiment depicted in FIG. 4A, a target membrane 30 including a target GPCR 40 and a reference membrane 230 containing a reference GPCR 240 are printed on a microspot 20 of an array 10. In the assay reaction shown in FIG. 4B, an assay solution containing a labeled ligand 68 to target GPCR 40 and a labeled agent 78 to reference GPCR 240 may be contacted with a microspot containing both target membrane 30 and reference membrane 230. Labeled ligand 68 binds with target GPCR 30 and labeled agent 78 binds to reference GPCR 240. After washing unbound labeled ligand 68 and labeled agent 78 from the microspot, a signal associated with the first label 75 of labeled agent 78 and a signal associated with the second label 65 of labeled ligand 68 may be detected, e.g., as described above. The signal associated with the first label 78 and thus the reference membrane 240 may be used to normalize the signal detected from the second label 68 and thus the target membrane; e.g., as described above. However, it will be understood that, if the reference membrane 240 contains appreciable amounts of downstream effectors of reference GPCR 240, such as G-protein, then functional assays in which indicators of downstream effects ligand 60 binding to GPCR 40 are measured, such as bound, labeled GTPγS, may be masked by effects associated with reference membrane 230 and reference GPCR 240, as agent 70 may effectuate downstream effects upon binding to reference GPCR 240.

As discussed above with regard to microspots 20 in which membrane component 50 is a component of the target membrane 30 (e.g, as described in association with FIGS. 2 and 3), prelabeling of a reference membrane 230 may be similarly advantageous. Referring to FIG. 5A, a target membrane 30 containing a GPCR 50 and a reference membrane 230 including prelabeled membrane component 50 (prelabeled with labeled agent 78) are printed on a microspot 20 of an array 10. In the depicted embodiment, the target membrane 30 includes membrane components 50 and is similar, e.g. obtained from the same cell type, to reference membrane 230, except that target membrane includes target GPCR 40. An assay solution may contain a labeled ligand 68 that can be contacted with the microspot 20 to allow ligand 60 to bind target GPCR 40, as shown in FIG. 5B. Signal from first label 75 associated with reference membrane 230 may be used to normalize signal from second label 65 associated with target GPCR 40 as described above.

The effectiveness of using a reference membrane 230 for purposes of normalization are based on the assumption that the relative amount of reference membrane 230 to target membrane 30 will remain constant throughout the printing process and assay procedure. Good results may be obtained employing a reference membrane 230 for normalization (see EXAMPLE 2). However, it will be understood that in some situations, the ability of a membrane to be retained by a surface 12 of an array 10 can vary depending on the type of membrane employed, the amount of GPCR incorporated in the membrane, and the like. Accordingly, it is preferred that reference membrane 230 and target membrane 30 be similar in origin and components.

While FIG. 2-5 depicts a receptor binding assays, it will be understood that a functional assay may be performed in a similar manner. In a functional assay, a molecule that may be affected downstream of receptor binding may be labeled with the second label 65. The labeled molecule serves as an indicator of the ability of a ligand 60 to effectuate a downstream effect. For example, GTPγS may be labeled, to determine the ability of a ligand 60 to cause binding of GTP to an alpha subunit of a G-protein as discussed above.

In the following, non-limiting examples are presented, which describe various embodiments of the arrays and methods discussed above.

### EXAMPLES

### Example 1

### Use of a Membrane Component of a Target Membrane as Reference for Normalization

Example 1 illustrates the use of a target membrane component as a reference for normalization as referenced in FIG. 2. Many components (protein, lipid, cholesterol, polysaccharide, etc.) of a target cell membrane could be used as a reference. As an example, we chose ganglioside G_{M1} as a reference. Ganglioside G_{M1} selectively partitions into a microdomain in the plasma membrane. The microdomain is called a lipid raft. Lipid rafts are detergent-insoluble, sphingolipid- and cholesterol-rich microdomains that form lateral assemblies in the plasma membrane. Lipid rafts sequester many signaling proteins and receptors and play a role in a variety of cellular processes. The beta subunit of cholera toxin (CT-B) is known to bind to the pentasaccharide chain of plasma membrane ganglioside G_{M1} with high affinity. To minimize cross-talk between fluorescent signals from GPCR targets and from references, we chose Alexa FL® 647 labeled CT-B (CT-B 647), available from Molecular Probes, as the probes for reference and Cy3 labeled ligands for GPCR targets.

1 ng/ml of CT-B 647 was added to GPCR binding assay solution (50 mM HEPES (pH7.5), 5 mM MgCl₂, 1 mM CaCl₂, 1:40 Blocker Casine (Pierce, Bradford, Wis.) and 0.05% BSA) containing Cy3 labeled ligands before incubation with GPCR arrays. At the end of one hour incubation, GPCR arrays were washed with distilled water using an automated strip washer ELx50™ from Bio-Tek® Instruments Inc. (Winooski, Vt.) and imaged for both Cy3 and Cy5 channels. The ratios of Cy3 channel binding signals to Cy5 channel were calculated to perform normalization. Assay CVs of a whole 96-well microplate were calculated with or without CT-B₆₄₇ normalization. Assay results demonstrated significant improvement of assay CV % when CT-B 647 was used for normalization. (Table 1). For example the assay CV of Bradykinin receptor was 39.5% before normalization. After normalization, the assay CV dropped to 11.5%. Another example is Muscarinic M2. Its assay CV decreased from 37.8% to 19.5%.

TABLE 1
Improvement of assay CV using target membrane referencing

| | | Adrenergic | | Muscarinic | | Muscarinic |
|---|---|---|---|---|---|---|
| GPCR | Apelin | β1 | Bradykinin | M1 | Urotensin 2 | M2 |
| Assay | 16.8 | 11.5 | 39.5 | 13.8 | 16.0 | 37.8 |
| CVb | | | | | | |
| Assay | 14.3 | 9.6 | 11.5 | 12.6 | 12.0 | 19.5 |
| Cvn | | | | | | |

CVb is assay CV before normalization;
CVn is assay after normalization
Assay solution: cocktail of 5 Cy3 labeled GPCR ligands and 1 ng/ml CT-B 647

The above two-color target membrane referencing methods can be extended to three-color or more-color referencing methods. For example, two fluorescence channels may be used for assay, and a third channel may be used for referencing. For example, both Cy3 and Cy5 labeled probes may be used for GPCR targets, and Alexa FL® 488 labeled CT-B may be used for reference. Results in Table 2 demonstrated significant improvement of assay CV % using a three-color target membrane as a referencing method. Lie using both Cy3 and Cy5 labeled probes for GPCR targets and Alexa FL®⁴⁸⁸ labeled CT-B for normalization.

Briefly, 1 ng/ml of CT-B₄₈₈ was added to GPCR binding assay solution (50 mM HEPES (pH7.5), 5 mM MgCl₂, 1 mM CaCl₂, 1:40 Blocker Casine and 0.05% BSA) containing both Cy3 and Cy5 labeled ligands before incubation with GPCR arrays. At the end of one hour incubation, GPCR arrays were washed with distilled water using an automated strip washer (ELx50™ from Bio-Tek® Instruments Inc.) and imaged for three channels, Cy3, Cy5 and FITC. The ratios of Cy3 channel binding signals to FITC channel and Cy5 channel binding signals to FITC channel were calculated to perform normalization. Assay CVs of a whole 96-well microplate were calculated with or without normalization. Assay results in Table 1 demonstrated significant improvement of assay CV % when CT-B 488 was used for normalization. For example the assay CV of Bradykinin receptor (Cy3 channel) before normalization was 18.9%. After normalization, the assay CV dropped to 4.6%. Another example is Neurotensin (Cy5 channel). Its assay CV decreased from 14.3% to 6.7.

TABLE 2
Improvement of assay CV using Three-color Direct In-Spot

| | Cy3 Ligands | | | | | Cy5 ligands | |
|---|---|---|---|---|---|---|---|
| GPCR | Apelin | Adrenergic b1 | Bradykinin | Muscarinic M1 | Urotenisn 2 | Galinin | Neurotensin |
| CVb | 6.0 | 3.9 | 18.9 | 7.9 | 6.6 | 9.7 | 14.3 |
| CVn | 3.9 | 2.9 | 4.6 | 3.8 | 5.0 | 4.8 | 6.7 |

Cvb is assay CV before normalization;
CVn is assay after normalization
Assay solution: cocktail of 5 Cy3/2 Cy5 labeled GPCR ligands and 1 ng/ml CT-B 488

### Example 2

### Use of a Reference Membrane for Normalization

Example 2 illustrates the use of a reference membrane for normalization as shown in FIGS. 4A and 4B.

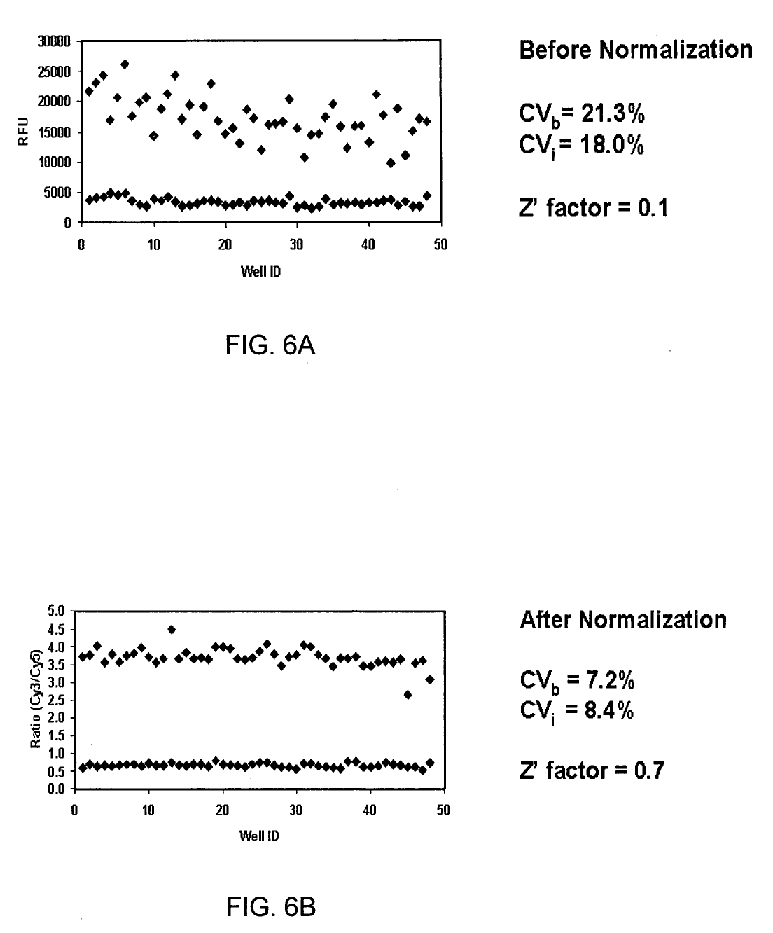

Target GPCR membrane preps (Urotensin II) were mixed with reference GPCR membrane preps (GalR2) and the mixture of two membrane preps were co-spotted on the substrate of an array. Cy3-Urotensin II and Cy5-Galanin were used as probes for target and reference GPCR, respectively. Briefly, 2 mg/ml of urotensin receptor was first mixed with 1 mg/ml of galanin receptor. The mixture was co-spotted on the substrate of an array. The array was then incubated with assay solutions (50 mM HEPES (pH7.5), 5 mM MgCl₂, 1 mM CaCl₂, 1:40 Blocker Casine and 0.05% BSA) containing both Cy3-Urotenin II and Cy5-Galanin. At the end of one hour incubation, GPCR arrays were washed with distilled water using an automated strip washer (ELx50™ from Bio-Tek® Instruments Inc.) and imaged for both Cy3 and Cy5 channels. The ratio of Cy3 channel binding signal to Cy5 channel binding signal was calculated and used to perform normalization. Assay CVs of a whole 96-well microplate were calculated with or without normalization. Assay results demonstrated significant improvement of both assay CV % and Z factor (FIG. 6). Assay Z factor refers to the Assay Window Coefficient.

As shown in FIG. 6, a significant improvement of assay performance occurs (CVs and Z′ factors) when using GPCR membrane preps as the reference. CV, defined above, is a measure of variation. With reference to these types of assays, a small CV value is preferred as a small CV value indicates a tightly controlled assay. Z′ is calculated as Z′=1−3×(SDb+SDi)/(Sb−Si) where Sb is the average binding signal in the absence of a competing compound, where each binding signal is the specific binding measured in RFU less the non-specific binding measured in RFU; SDb is the standard deviation of the Sb; Si is the average binding signal in the presence of a competing compound and SDi is the standard deviation of the Si. Z′ is a measure of the quality of the assay and falls in the range of 0-1. A higher Z′ number indicates a better assay. Negative Z′ is obtained when the assay fails. For the calculations of Z′, odd columns in a 96-well format (columns C1, C3, C5, C7, C9 and C11) were used for measuring total binding signal, and even columns (C2, C4, C6, C8, C10 and C12) were used for measuring non-specific binding. Values were averaged over three 96-well plates, or over 288 microspots.

FIG. 6A is a scatter plot of total binding and non-specific binding signals before normalization. Binding signals were measured in RFU, relative fluorescent units, the measure of the binding signal. Measurements were made of non-specific binding (dark squares) and total binding (light squares). Assay CVs were calculated. CVb, the measure of CV before the assay (without normalization) was 21.3% (CVb=100×SDb/Sb where Sb is the average binding signal in the absence of a competing compound and SDb is the standard deviation of the Sb). CVi, the CV calculated after the assay was 18.0% (without normalization) (CVi=100×SDi/Si where SDi is the standard deviation of the Si, the average binding signal in the presence of a competing compound). Z′ for the assay before normalization was 0.1. FIG. 6B is a scatter plot of total binding (light squares) and non-specific binding (dark squares) measured in RFU, after normalization. Assay CVs were calculated based on this information. CV_{b}, the measure of CV before the assay with normalization was 7.2% (reduced from 21.3% without normalization). CVi, the measure of CV after the assay with normalization was 8.4% (reduced from 18.0% without normalization) and the Z′ factor was calculated to be 0.7 with normalization (an increase from 0.1).

In another experiment, a fluorescent dye labeled control membrane prep was used as a reference membrane prep. It was first mixed with target GPCR membrane preps prior to printing. The probe for target has a distinct wavelength from the label on the reference membrane preps. As an example, HEK control membrane preps were labeled with CTB₆₄₇. Probes for GPCR APJ, B1, BK2, M1 and UT were all labeled with Cy3 dyes. Multiplexed binding assay performance was significantly improved using labeled membrane preps as reference (Table 3).

Briefly, 50 μg of control cell membrane isolated from HEK293 cell lines was incubated with 5 μg of CT-B₆₄₇ at 4° C. for 30 minutes. The membrane was then washed 3 times with PBS (phosphate balance buffer) to remove free CT-B₆₄₇. 2 mg/ml of each GPCRs was first mixed with 1 mg/ml of CT-B₆₄₇ labeled HEK293 membrane and co-spotted on the substrate of an array. The array was then incubated with assay solutions (50 mM HEPES (pH7.5), 5 mM MgCl₂, 1 mM CaCl₂, 1:40 Blocker Casine and 0.05% BSA) containing BT-apelin, BT-CGP12177, BT-Hoe140, Cy3B-telenzepine and BT-urotenin II. At the end of one hour incubation, GPCR arrays were washed with distilled water using an automated strip washer (ELx50™ from Bio-Tek® Instruments Inc.) and imaged for both Cy3 and Cy5 channels. The ratio of Cy3 channel binding signal to Cy5 channel signal was calculated and used for normalization. Assay CVs of a whole 96-well microplate were calculated with or without normalization. Assay results (Table 3) demonstrated significant improvement of both assay CV % and Z factor. For example, the Z factor of Apelin was improved from −0.2 to 0.5; the CV of Apelin was improved from 15.4% to 5.4%.

TABLE 3
Improvement of assay performance using labeled
reference membrane preps.

| | | Adrenergic | | Muscarinic | Urotensin |
|---|---|---|---|---|---|
| GPCR | Aeplin | β1 | Bradykinin | M1 | 2 |
| Assay | 15.4 | 7.1 | 45.4 | 40.0 | 4.9 |
| CVb | | | | | |
| Assay | −0.2 | −.01 | −1.4 | 0.0 | 0.7 |
| Z′b | | | | | |
| Assay | 5.4 | 7.1 | 21.1 | 24.4 | 7.3 |
| CVn | | | | | |
| Assay | 0.5 | 0.5 | 0.3 | 0.2 | 0.7 |
| Z′n | | | | | |

CVb is assay CV before normalization;
CVn is assay CV after normalization
Z′b is assay Z′ factor before normalization;
Z′n is assay Z′ factor after normalization
Assay solution” cocktail of 5 Cy3 labeled GPCR ligands

### Example 3

### Pre-Labeling of Target Membrane for Normalization

In Example 3, pre-labeled target membranes are used for normalization as shown in FIGS. 5A and 5B. During the development of GPCR array technology, missing or weak spots after GPCR binding assay are often a source of concern. Reasons for missing or weak spots include: 1) membrane prep remained on the substrate, but it was not functionally active; and 2) membrane prep was loosely attached on the substrate and was washed off during washing process after assay. Currently there is no tool to identify the problem. A researcher commonly hypothesizes that the missing spots after assay/washing process was due to the deposited membrane being washed away. However, this may not always be the case.

A simplified prelabeling protocol has been developed that enables same-day array printing to avoid any loss of activity during freezing/thawing process. As compared to the conventional binding assay results, the prelabeled GPCR membrane exhibited an equivalent binding activity and assay specificity, which are two criteria for evaluating the functional integrity of the GPCR membrane. The results also showed that the prelabeled signal is proportional to the assay signal. Normalization that employs the ratio of target signal (excited at Cy3 or Cy5 channel) to prelabeled signal (excited at a universal channel, FITC channel) has significantly reduced assay CV and increased Z factor. In addition to normalization, the successful prelabeling of GPCR membrane has enabled various important applications including the ability to monitor membrane retention throughout the entire assay, the ability to normalize the assay, and the ability to quality control the preparation between the printing and the assay

A. Prelabeling of GPCRs Membrane Preparations.

Prelabeling GPCRs membrane by following conventional membrane labeling method does not produce active GPCRs membrane. Not only has recovery rate been very low (<30%), but also the prelabeled GPCR membrane showed very low binding activity and assay specificity as compared to a conventional binding assay results. Therefore, in embodiments of the present invention, GPCR membranes were prelabeled according to a modified protocol. The modified protocol includes labeling GPCRs membrane directly in the stock solution as supplied by a manufactures in a largely reduced volume to reduce the loss of membrane during washing process. In addition, the wash solution included a carrier (BSA) to increase recovery (>90%) and to avoid the need to further quantify protein concentration in order to have sufficient prelabeled membrane for subsequent binding assay. Following washing, the membrane was precipitated and resuspended directly in a buffer suitable for printing. The modified protocol has dramatically reduced sample preparation time and allows for same day printing and provides for improved binding properties relative to conventional protocols.

An example of suitable prelabeling of GalR2 membrane preparation was performed as follows. 40 μg of GalR2 (in 14 μl stock solution from Perkin-Elmer), 2 μl of Alexa FL® 488 labeled CT-B (CTB 488, Molecular Probes) (10 μg/ml), and 15 μl of PBS were mixed on ice for 30 min. During waiting period, washing solution and reformulation buffer were prepared. Washing solution consisted of PBS supplemented with 0.5% BSA. This ingredient is present in the subsequent reformulation buffer used for printing. Accordingly, the addition of 0.5% BSA does not affect subsequent array printing. After 30 min incubation, the membrane prep was precipitated by centrifugation at 14,000 rpm for 5 min, and the supernatant was discarded, and pellet was resuspended in above washing solution. To remove non-specifically bound free dye, the pellet was resuspended in 20 μl of the washing buffer by pipetting up and down, vortex, and sonicated in water bath for 30 sec. Then, the membrane prep was precipitated by centrifugation at 14,000 rpm for 5 min (the above washing process was repeated twice). The final pellet was resuspended in the printing buffer (75 mM Tris-HCL (pH 7.4), 12.5 mM MgCl2, 1 mM EDTA, 5% Glycerol, 10% Sucrose, 0.5% BSA). To homogenize the membrane prep, the prelabeled GalR2 prep was sonicated with cup-horn sonicator using automated programmed condition: power 8, one continuous 10 sec plus 25 pulsing (1 sec on and 1 sec off). The sonicated sample was directly used for GPCR array printing. Array was printed at 3×9 format (9 columns per array with triplicate for each column) using Cartesian™ Printer.

In an alternate embodiment, a solution of cy3 or cy5 (or a mixture of cy3 and cy5) labeled streptavidin (Sv) can be included in the universal buffer used for membrane printing (PBS buffer with BSA), and the GPCR membrane prep may be introduced into this universal buffer solution containing the cy3 or cy5 labeled Sv by sonication. The sonication step leads to the association of the labeled Sv to the GPCR membrane. The labeled Sv may then be used as a reference. This approach could be used with additional dye labeled proteins, known in the art.

B. Prelabeling does not Affect GPCR Functionality.

The primary concern for prelabeling of membrane prep is that the labeled membrane may lose its functionality. To demonstrate the effectiveness of prelabeling, the binding assay results with prelabeled membrane prep and its non-labeled counterpart were compared, in terms of their total biding activity and assay specificity. The binding assay for non-labeled membrane prep was performed where a target membrane (GalR2) was mixed with a reference membrane (Muscarinic M1 from Euroscreen) for normalization purposes, based on the similar principle as described in EXAMPLE 2.

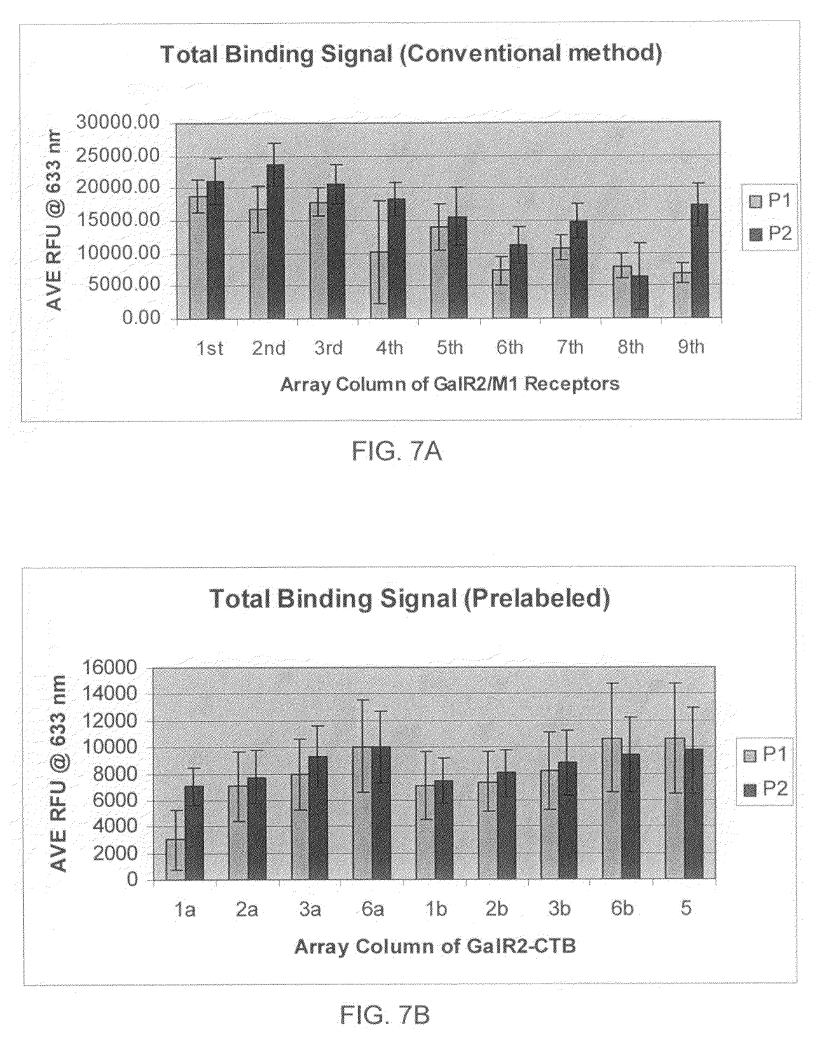

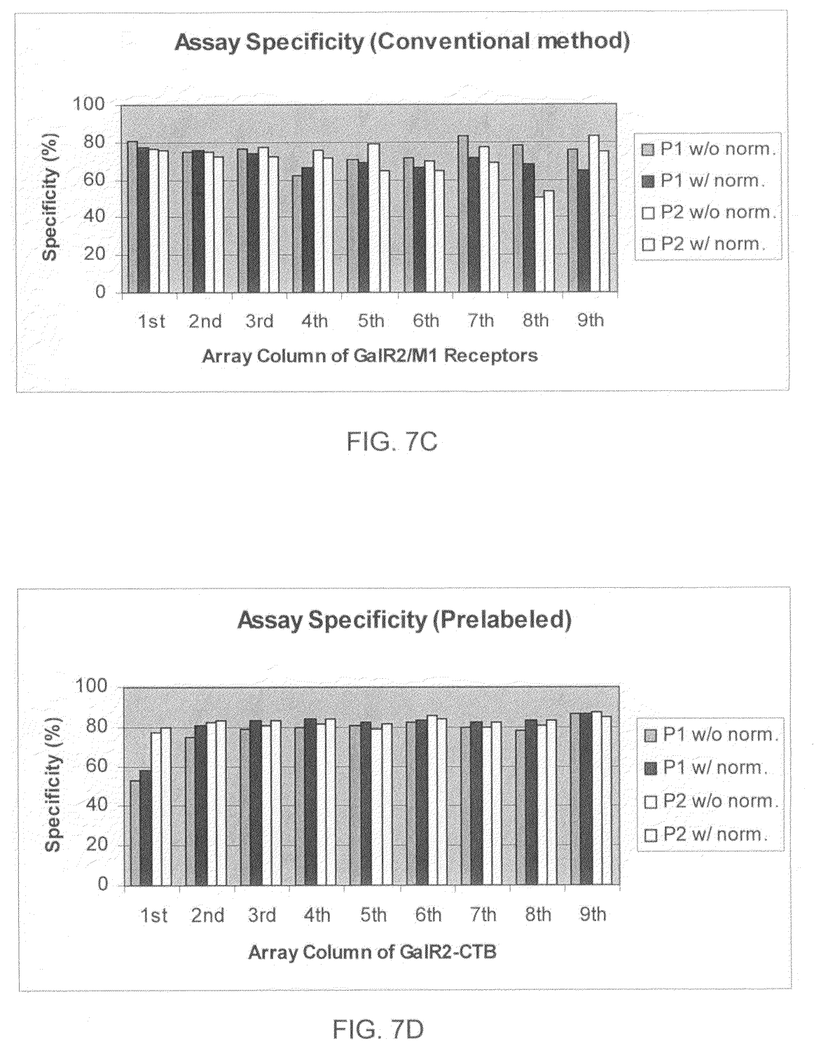

As shown in the bar graphs of FIG. 7, illustrating Average RFU measured without (FIG. 7A) and with (FIG. 7B) prelabeling, the prelabeling does not appear to affect GPCR binding activity and assay specificity. The results presented in FIG. 7 are from assays carried out in 96-well microplates. Binding assay format is: Columns 1 though 11 (C1-C11) were used for measuring total binding signal, in which a mixture of fluorescence labeled ligands (1 nM BODIPY® TMR-CGP12177, a ligand for β1 Adrenergic receptor; 0.8 nM BODIPY® TMR-Apelin13, a ligand for Apelin receptor; 1 nM or 2 nM Cy5-Galanin, a ligand for Galanin receptor; 0.5 nM Cy3B-Telenzepine, a ligand for Muscarinic M1 and M2 receptors; 2 nM Cy5-Neurotensin 2-13, a ligand for Neurotensin receptor; 0.125 nM BODIPY®-TMR-HOE140, a ligand for Bradykinin receptor) were added in assay solution (as described in Example 2); Column 12 was used for measuring non-specific binding signal, in which a mixture of compounds (1 μM CGP 12177, 1 μM Apelin-12 (human, bovine, mouse, rat), 1 μM Neurotensin 1-8, 1 μM Galanin, 1 μM Bradykinin, 1 μM HOE 140) was supplemented in the assay solution for C1-C11. Values were averaged over 96-well with triplicate in each well, or over 288 microspots. Assay specificity was calculated as (average of total binding signal from C1-C11−average of nonspecific signal from C12)×100%.

The data obtained for FIGS. 7A and 7C were from pre-mixed and co-printed GalR2 (target) and M1 (reference) receptors. Nine tubes of GalR2/M1 were prepared individually. P1 and P2 indicate plate 1 and plate 2, where the two experiments were performed in duplicate.

The data obtained for FIGS. 7B and 7D were “prelabeled” and were from GalR2 membranes prelabeled as described above. Prelabeling was done as follows: four tubes of GalR2 receptor preps were labeled individually, and each labeled GalR2 was loaded in duplicate: 1st=5th; 2nd=6th; 3rd=7th; 4th=8th.

The same amount of GalR2 membrane prep was used for both cases (un-prelabeled and prelabeled). The binding assay were performed under the same condition except the concentration of Cy5-GalR2 was 2.0 nM for the “conventional” assay and was 1.0 nM for the “prelabeled” assay.

C. Monitoring Membrane Retention and Isolating and Identifying the Problems by Using Prelabeled Membrane Preparation

GalR2 was prelabeled with CTB-488 in accordance with above protocol and array was printed in 3×9 format. Images presented in FIG. 8 were obtained from GenePix Pro 6.0. FIG. 8A shows GalR2 binding assay results at Cy5 channel, as a result of Cy5-GalR2 bound to GalR2 receptor. FIG. 8B shows printed array spots before assay/washing process at FITC channel (PMT gain 180), as a result of prelabeled membrane with CTB-488. FIG. 8C shows array spots left after assay/washing process at FITC channel (PMT gain 200). Images in FIGS. 8 B and C were obtained at the same setting during the image acquisition process except for PMT gain. During the binding assay, array spots are submerged in the solution containing a mixture of fluorescence labeled probes including Cy5-GalR2 probe for one hour. Then the array was washed with distilled water using an automated strip washer ELx50™ from Bio-Tek® Instruments Inc. Due to affinity binding between GalR2 receptor and its Cy5 dye labeled ligand (Cy5-GalR2), the array spots can be visualized by scanning at Cy5 channel. Columns 1, 2, and 7 of FIG. 8A showed very week or no signals as compared to the rest of spots. Previously, this phenomenon was diagnosed as the result of excessive washing, where loosely bound membrane prep was washed away during washing process. However, with the comparison of fluorescence signals before and after assay/washing process at FITC channel, it clearly shows the array spots in C1 and C2 remained after assay/washing process, suggesting that the weak signals after assay at C1 and C2 was not because of membrane being washed away, but rather was due to the loss of binding activity for unknown reason. On contrary, the missing spots in C7 after assay appear to be due to a printing problem. With the prelabeling approach, issues associated with printing, assay and washing process are isolated.

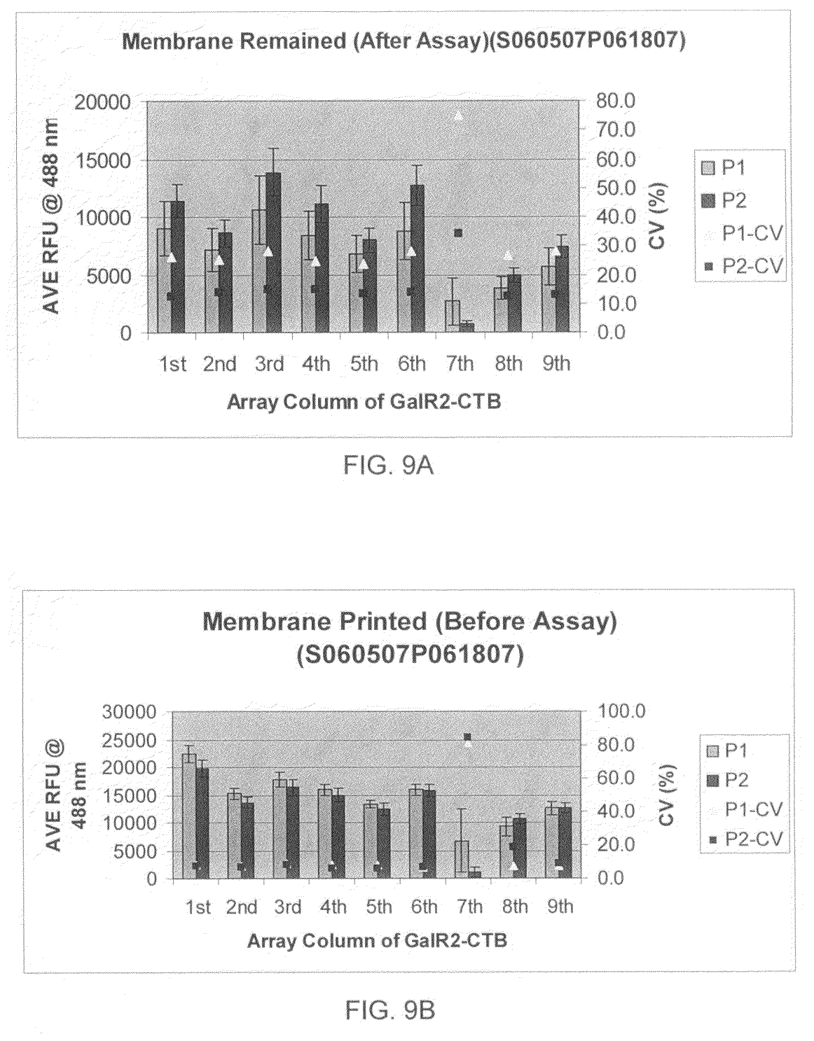

FIGS. 9A and 9B show fluorescence signals measured from printed arrays before (FIG. 9A) and after (FIG. 9B) assays were performed. These measurements illustrate that by using a prelabeling method, measurements can be taken before and after an assay to measure the remaining fluorescence, allowing for an additional quality control measurement.

D. Normalization by Using the Ratio of Target Signal to its Prelabeled Signal

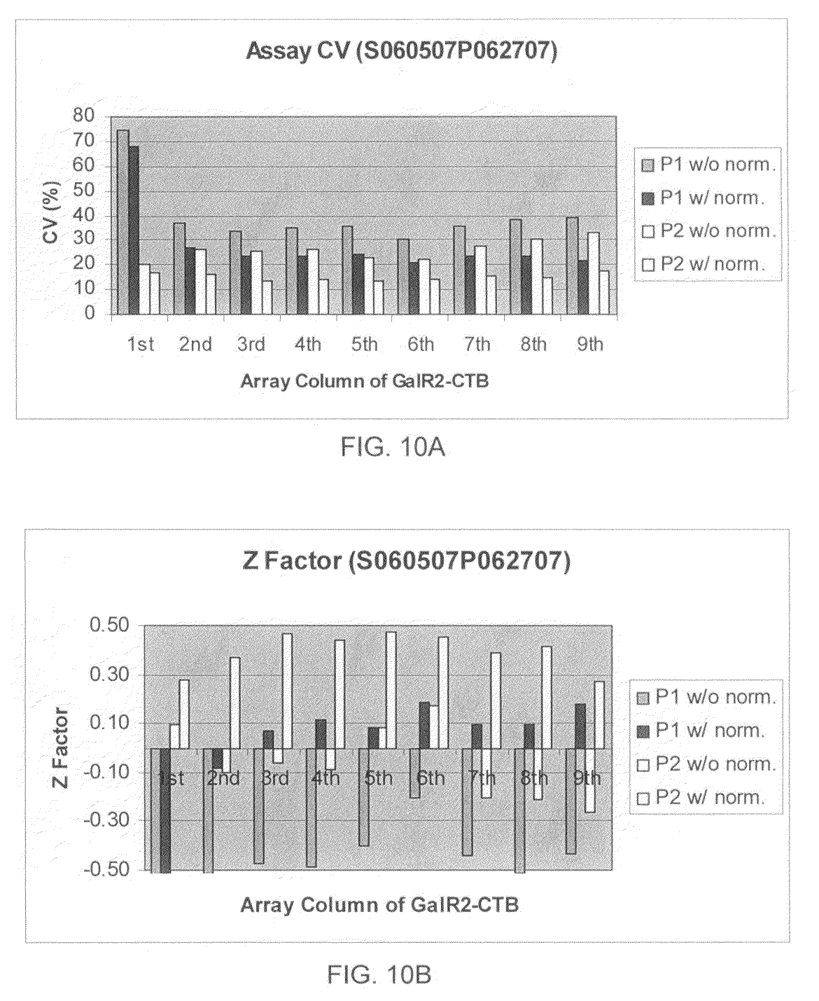

Normalization of assay data by using the ratio of assay signal at Cy5 channel and signal from prelabeled signal at FITC channel has significantly reduced assay CV and increased assay Z factor as shown in FIGS. 10A-B. FIG. 10A illustrates CV(%), as defined is a measure of variation. FIG. 10B illustrates Z. Z is calculated as 1-3×(SD_{C1-C11}+SD_{C12})/(S_{C1-C11}−S_{C12}), SD is the standard deviation, S is the average binding signal. P1 and P2 indicate plate 1 and plate 2, where the two experiments were performed in duplicate. A negative Z indicates a negative assay. As shown, using a normalization process, assay Z factors improved significantly.

E. Quality Control Check at Prescan by Suing Prelabeled Membrane Preparation

Because a complex process is involved in array technology, it is often desirable to perform a quality control check before performing a binding or functional assay. Due to lack of efficient method, people commonly perform a quality check by scanning printed GPCR array at Cy3 channel at 532 nm via autofluorescence (essentially all substance emit fluorescence signal at 532 nm, including membrane itself, ingredients from stock buffer, such as BSA and salts, or even dust or fingerprint accidentally left on the glass bottom insert). Therefore, autofluorescence does not correlate with the amount of membrane prep printed. On the contrary, the amount of membrane prep is proportional to the prelabeled fluorescence. The low pre-scan CV implies the low assay CV.

As shown in FIGS. 11A and 11C (with reference to FIGS. 7B and 7D), the assay signal at Cy5 channel correlates well with the prelabeled fluorescence signal at FITC but not with the autofluorescence signal at Cy3 channel. FIG. 11A shows the total fluorescence signal at FITC channel after printing but before the assay (prescan). FIG. 11C shows the total binding fluorescence signal at Cy5 channel after assay. FIG. 11B shows autofluorescence signal at the prescan (before assay but after printing). FIG. 11B represents methods for checking quality after printing but before the assay using known methods. The data shown in FIGS. 11A and 11C have better correlation than that shown in FIG. 11B using autofluorescence. Pre-scanned signal using pre-labeled preparations can predict final assay closely, better than using autofluorescence without pre-labeling. Except for C1, the higher the signal at pre-scan, the higher the total binding signal at assay. For example, as shown in FIG. 11A, the prescan signals increase slightly from array columns 2^{nd} to 4^{th} and from the array columns 5^{th} to 8^{th}. Accordingly, the assay signals slightly increase from array columns 2^{nd} to 4^{th} and from the array columns 5^{th} to 8^{th} as shown in FIG. 11C, respectively. However, the same trends are not observed in FIG. 11B. In addition, the prescan CV at prelabeled channel (FITC) showed better correlation to the final assay CV than that at Cy3 channel (autofluorescence). Therefore, one can better predict the assay result by performing prescan at prelabeled channel than at autofluorescence channel. Prelabeled membrane may provide a better quality control over the known method using autofluorescence

With the comparison of prelabeled signals obtained before and after assay, we are also able to compare the membrane retention among nine columns in an array. Typically, the signal at the edge of the array, very often in C1 (sometime C9) looses more membrane compared to the rest of array columns. The low assay signal in C1 or C9 is believed to be related to uneven force in the washing manifolds. As shown in FIG. 9B, C1 displayed the highest prescan signal, and followed by C3 and C6; however, after assay, the C1 is not longer the highest while the C3 and C6 remained the same rank, as shown in FIG. 9A. Therefore, using embodiments of the present invention, problems associated with washing are easily detectable.

F. Normalization by Incorporating a Label into GPCR Membrane Preparation

Normalization of GPCR assays may also be accomplished by incorporating a label into the membrane prep. For example, streptavidin (Sv) may be incorporated into the prep by sonication. GPCR membrane samples B1_Sv & M2_Sv has Cy™5-Streptavidin added to samples for purpose of normalization during binding assay. Sample GAL_Sv has Cy™3-Streptavidin added to sample for purpose of normalization during binding assay. Samples were centrifuged at 14,000 rpm for 10 min @ 4° C., supernatant was removed and discarded and 45 ul reformulation buffer was added to each sample Cy™5-Streptavidin was added to reformulation buffer in a 1:1200 dilution, Cy™3-Streptavidin was added to reformulation buffer in a 1:800 dilution.

The pelleted samples were then sonicated for 25 sec at 4° C. in microtubes containing reformulation buffer using a cuphorn sonicator. A quick centrifugation at 9,000 rpm, a quick sonication 1 sec pulse×15 pulses at 4° C., another quick centrifugation at 6,000 rpm and another sonication 1 sec pulse×4 pulses at 4° C. were performed.

Reformulated samples were then printed by loading into a 384 low volume plate and kept at ˜4° C. while printing onto glass substrate coated with surface chemistry. Samples were printed with Telechem 946 MP3 micro spotting pins. Relative humidity was kept between 40-45%. After printing, glass substrates with printed GPCR array were incubated in ˜70% relative humidity at room temperature for 45 minutes. Following humidity treatment, glass substrates with printed GPCR arrays were incubated in ˜10% relative humidity in a mostly nitrogen atmosphere at room temperature for 45 minutes. Glass sheets with printed GPCR array were transferred to 4° C. until binding assay.

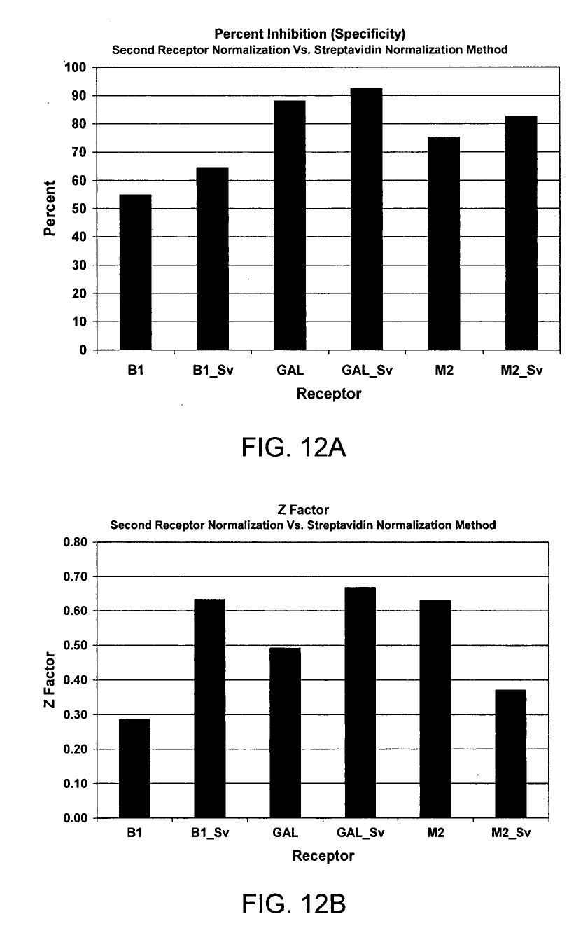

The Binding assay was performed as described. Printed GPCR arrays were allowed to warm to room temperature. Printed GPCR arrays were incubated in ˜70% relative humidity to re-hydrate printed GPCR's. Binding assay solutions were prepared. Labeled ligands were added to binding assay solutions, and binding assay solutions containing the labeled ligands were split for one half to receive the un-labeled ligands added for competition assay. Binding assay solutions containing labeled ligands and labeled/un-labeled ligands were added to microwell plate containing printed GPCR arrays. After 1 hour incubation at room temperature, plates were washed and dried using microplate washer. Plates were scanned using Tecan scanner utilizing Cy3 and Cy5 wavelengths. Binding signals of labeled ligands were normalized to either the Cy™3-Streptavidin or Cy™5-Streptavidin or to the second GPCR added to the sample prior to printing. Percent inhibition or specificity was calculated by comparing the labeled ligand binding signal to the signal of the samples containing the mixture of the labeled and un-labeled ligands. Results of these experiments are shown in FIGS. 12A and 12B. FIGS. 12A and 12B illustrate specificity and Z factor related to this streptavidin method, compared to results obtained using the second receptor method, the method illustrated in FIGS. 4A and 4B.

Thus, embodiments of NORMALIZATION METHODS FOR G-PROTEIN COUPLED RECEPTOR ARRAY are disclosed. One skilled in the art will appreciate that the arrays, compositions, kits and methods described herein can be practiced with embodiments other than those disclosed. The disclosed embodiments are presented for purposes of illustration and not limitation.

What is claimed is:

1. A reference prelabeled G-protein coupled receptor membrane array comprising a plurality of assayable microspots, wherein one or more of the plurality of the microspots comprise:
a membrane comprising (i) a target G-protein coupled receptor embedded the membrane and (ii) a membrane component; and
a labeled agent bound to the membrane component.

2. The array of claim 1, wherein the membrane is isolated from a cell overexpressing the G-protein coupled receptor.

3. The array of claim 1, wherein the labeled agent comprises a labeled beta subunit of cholera toxin or a labeled GPCR ligand.

4. A reference prelabeled G-protein coupled receptor membrane array comprising a plurality of assayable microspots, wherein one or more of the plurality of the microspots comprise:
a first membrane comprising a target G-protein coupled receptor embedded the membrane;
a second membrane comprising a membrane component;
a labeled agent bound to the membrane component; and
wherein the first membrane is isolated from a cell overexpressing the G-protein coupled receptor and wherein the second membrane is isolated from a non-overexpressing cell.

5. The array of claim 4, wherein the first and second membranes are isolated from cells having a common origin in their respective lineages.

6. The array of claim 4, wherein the labeled agent comprises a beta subunit of cholera toxin.

7. A method comprising:
Providing an isolated membrane from a cell overexpressing a G-protein coupled receptor, the membrane comprising a component;
contacting the membrane with a labeled agent configured to bind the component to produce a pre-labeled membrane; and
printing the pre-labeled membrane as a microspot on a substrate.

8. The method of claim 7 wherein contacting the membrane with a labeled agent comprises sonicating a printing buffer containing a labeled agent with the membrane from a cell overexpressing a G-protein coupled receptor to form a labeled membrane.

9. The method of claim 8 wherein the labeled agent is a dye labeled protein.

10. The method of claim 9 wherein the labeled protein is a cy3 or cy5 labeled streptavidin.

11. The method of claim 7, wherein contacting the membrane with a labeled agent comprises contacting the membrane with a labeled agent directly in a stock solution in a minimal volume.

12. The method of claim 7, wherein the printing occurs following the contacting without intervening freezing of the pre-labeled membrane.

13. The method of claim 7, further comprising washing the pre-labeled membrane in a solution comprising a carrier configured to enhance recovery of the pre-labeled membrane following centrifugation.

14. The method of claim 13, wherein the carrier is present in the solution used for the printing of the pre-labeled membrane.

15. A method comprising:
providing a first membrane from a cell overexpressing a G-protein coupled receptor;
isolating a second membrane from a non-overexpressing cell, the second membrane comprising a component;
contacting the second membrane with a labeled agent configured to bind the component to produce a pre-labeled second membrane; and
printing the first and pre-labeled second membrane as a microspot on a substrate.

16. The method of claim 15, further comprising mixing the first and pre-labeled second membranes.

17. The method of claim 15, wherein the first and second membranes are isolated from cells having a common origin in their respective lineages.

18. The method of claim 15, wherein contacting the second membrane with a labeled agent comprises contacting the second membrane with a labeled agent comprising a beta subunit of cholera toxin.

19. A method comprising:
contacting a microspot of a G-protein coupled receptor membrane array with labeled non-hydrolysable GTP analog;
contacting the microspot with a first labeled agent configured to bind a membrane component other than the G-protein coupled receptor to produce a reference labeled membrane;
contacting the microspot with a ligand suspected of being capable of functionally interacting with the G-protein coupled receptor;
rinsing the microspot to remove unbound labeled non-hydrolysable GTP analog, unbound first labeled agent, and unbound ligand from the microspot;
quantifying a first signal associated with the labeled non-hydrolysable GTP analog associated with the microspot;
quantifying a second signal associated with the first labeled agent bound to the membrane component; and
comparing the first signal with the second signal to determine the extent of the functional interaction of the agent with the G-protein coupled receptor.

20. The method of claim 19, wherein contacting the microspot with the labeled non-hydrolysable GTP analog, contacting the microspot with the first labeled agent, and contacting the microspot with the ligand comprise contacting the microspot with a composition comprising the labeled non-hydrolysable GTP analog, the first labeled agent and the ligand.

21. The method of claim 19 further comprising contacting the reference labeled membrane with a second labeled agent capable of producing a signal and configured to bind to the first labeled agent, and wherein quantifying the second signal associated with the first labeled agent comprises quantifying the signal associated with the second labeled agent.

22. The method of claim 19, wherein the first labeled agent is configured to bind ganglioside G_{M1}.

23. A method comprising:
contacting a microspot of a G-protein coupled receptor membrane array with a first labeled agent;
contacting the microspot with a second labeled agent configured to bind a membrane component;
rinsing the microspot to remove unbound first labeled agent and unbound second labeled agent;
quantifying a first signal associated with the first labeled agent associated with the microspot;
quantifying a second signal associated with the second labeled agent bound to the membrane component; and
comparing the first signal with the second signal to determine the extent of binding of the second labeled agent to membrane component.

24. The method of claim 23, wherein contacting the microspot with the first labeled agent and contacting the microspot with the second labeled agent comprise contacting the microspot with a composition comprising the first and the second labeled agents.

25. The method of claim 23, further comprising contacting the labeled membrane with a third labeled agent capable of producing a signal and configured to bind to the first labeled agent, and wherein quantifying the signal associated with the third labeled agent comprises comparing the signal associated with the first labeled agent with the signal associated with the third labeled agent.
